(19) United States
(12) Patent Application Publication
(10) Pub. No.: US 2011/0152109 A1
(43) Pub. Date: Jun. 23, 2011

(54) BIOLOGICAL SAMPLE TARGET CLASSIFICATION, DETECTION AND SELECTION METHODS, AND RELATED ARRAYS AND OLIGONUCLEOTIDE PROBES

(76) Inventors: Shea N. Gardner, Oakland, CA (US); Crystal J. Jaing, Livermore, CA (US); Kevin S. McLoughlin, Emeryville, CA (US); Thomas R. Slezak, Livermore, CA (US)

(21) Appl. No.: 12/643,903

(22) Filed: Dec. 21, 2009

(51) Int. Cl. C40B 30/02; C40B 40/08

(52) U.S. Cl. 506/8; 506/17

(57) ABSTRACT

Biological sample target classification, detection and selection methods are described, together with related arrays and oligonucleotide probes.

### STATEMENT OF GOVERNMENT GRANT

The United States Government has rights in this invention pursuant to Contract No. DE-AC52-07NA27344 between the U.S. Department of Energy and Lawrence Livermore National Security, LLC, for the operation of Lawrence Livermore National Security.

### FIELD

The present disclosure relates to arrays, methods and systems for pan microbial detection. In particular, the present disclosure relates to biological sample target classification, detection and selection methods, and related arrays and oligonucleotide probes.

### BACKGROUND

Various approaches for detecting microbial presence are based on use of arrays and in particular, probe microarrays.

Microarrays can be used for microbial surveillance, detection and discovery. These arrays probe species-specific or conserved regions to enable detection of novel organisms with some homology to the probes designed from sequenced organisms. Detection microarrays have proven useful in identifying, subtyping, or discovering viruses with homology to known viruses (see references 4, 10, 11, 15, 16, 18, 21, 23, 24 and 25).

Bacterial detection arrays to date have focused on highly conserved rRNA regions (16S or 23S) (see references 1, 5, 9, 14, 24) allowing specific rather than random PCR to amplify the target region with highly conserved primers. Virus diversity precludes the identification of a particular gene universally conserved at the nucleotide level for viruses, and viral probe design requires consideration of many genes or whole genomes.

The ViroChip discovery array played a role in characterizing SARS as a coronavirus (see references 16, 22 and 23). It was built using techniques for selecting probes from regions of conservation based on BLAST nucleotide sequence similarity to viruses in the respective viral family, such that all viruses sequenced at the time of design (2004) would be represented by 5-10 probes. Version 3 of the Virochip included approximately 22,000 probes. Chou et al. (see reference 4) designed conserved genus probes and species specific probes covering 53 viral families and 214 genera, requiring 2 probes per virus.

### SUMMARY

Provided herein in accordance with several embodiments of the present disclosure are biological sample target classification, detection and selection methods, and related arrays and oligonucleotide probes.

According to a first aspect, a method to obtain a plurality of oligonucleotide probes for detection of targets of a target group is provided, comprising: identifying group-specific candidate probes from an initial genomic collection by eliminating from the initial collection regions with matches to non-group targets above a match threshold and by selecting regions satisfying probe characteristics, said probe characteristics including at least one criterion selected from length, Tₘ, GC %, maximum homopolymer length, homodimer free energy prediction, hairpin free energy prediction, probe-target free energy prediction, and minimum trimer frequency entropy condition; ranking the group-specific candidate probes in decreasing order of number of targets of the target group represented by each group-specific candidate probe; and selecting probes from the ranked group-specific candidate probes.

According to a second aspect, a method of classifying an oligonucleotide probe sequence as detected or undetected in a biological sample is provided, comprising: incubating fluorescently labeled target DNA synthesized from templates extracted from a biological sample on an array comprising a plurality of probes, to allow for hybridization of target DNA to any probes of the array having sequences similar to those of the target DNA, producing a variable number of target-probe hybridization products for each probe sequence; scanning the array to measure an aggregate fluorescence intensity value for each feature comprising a set of target-probe hybridization products having probes of the same sequence; calculating the distribution of feature intensity values for target-probe hybridization products by way of negative control probes with randomly generated sequences, and setting a minimum detection threshold for the array; and comparing the observed feature intensity value for each probe sequence with the minimum detection threshold determined for the array, to classify each probe sequence on the array as either detected or undetected in the biological sample.

According to a third aspect, a method of predicting likelihood of presence of a target of known nucleotide sequence in a biological sample is provided, comprising: applying the method according to the above second aspect to classify probe sequences on an array as detected or undetected in the sample; estimating, for each detected probe sequence: i) a probability of observing the probe sequence as detected conditioned on presence of the target of known nucleotide sequence; ii) a probability of observing the probe sequence as detected conditioned on absence of the target of known nucleotide sequence; and iii) the detection log-odds, defined as the ratio of i) and ii); estimating, for each undetected probe sequence: iv) a probability of observing the probe sequence as undetected conditioned on presence of the target of known nucleotide sequence; v) a probability of observing the probe sequence as undetected conditioned on absence of the target of known nucleotide sequence; and vi) the nondetection log-odds, defined as the ratio of iv) and v); summing detection and nondetection log-odds values over the probes on the array to form an aggregate log-odds score for presence versus absence of the target of known nucleotide sequence, conditional on the observed detected and undetected probes; and based on the aggregate log-odds score, providing a prediction of the presence of at least one said target of known nucleotide sequence in the biological sample.

According to a fourth aspect, a selection method for selecting, from a list of candidate target sequences of known nucleotide sequence, a target sequence most likely to be present in a biological sample is provided, the selection method comprising: applying the method according to the above third aspect to each of the candidate target sequences, and choosing the target sequence that yields the maximum aggregate log-odds score.

According to a fifth aspect, a selection method for selecting, from a list of candidates, a set of targets whose presence in a biological sample would collectively provide the best explanation for observed detected and undetected probes on an array is provided, comprising: a) applying the above method to identify the target most likely to be present in the sample; b) removing the identified target from the list of candidates and adding the identified target to the “selected” list; c) repeating the method of claim 17 for the remaining candidates, wherein: c1) estimation of i), ii) and iii) is replaced with estimation of: i′) a probability of observing the probe sequence as detected conditioned on presence of the candidate target and presence of targets in the list of selected targets; ii′) a probability of observing the probe sequence as detected conditioned on absence of the candidate target and presence of targets in the list of selected targets; and iii′) the detection log-odds, defined as the ratio of i′) and ii′); c2) estimation of iv), v) and vi) is replaced with estimation of: iv′) a probability of observing the probe sequence as undetected conditioned on presence of the candidate target and presence of targets in the list of selected targets; v′) a probability of observing the probe sequence as undetected conditioned on absence of the candidate target and presence of the targets in the list of selected targets; and vi′) the nondetection log-odds, defined as the ratio of iv′) and v′); c3) the detection and nondetection log-odds values are summed over the probes on the array to form a conditional log-odds score for presence versus absence of the candidate target, conditioned on the observed detected and undetected probes and on the presence of the targets in the list of selected targets; d) choosing the candidate target yielding the maximum conditional log-odds score, removing it from the candidate list, and adding it to the list of selected targets; and e) repeating c) and d) until the conditional log-odds scores for all remaining candidate targets are less than zero.

The methods, arrays and probes herein provided are useful for the detection of viral and bacterial sequences from single or mixed DNA and RNA viruses derived from environmental or clinical samples.

The details of one or more embodiments of the disclosure are set forth in the accompanying drawings and the detailed description and examples below. Other features, objects, and advantages will be apparent from the detailed description, examples and drawings, and from the appended claims.

### BRIEF DESCRIPTION OF THE DRAWINGS

The accompanying drawings, which are incorporated into and constitute a part of this specification, illustrate one or more embodiments of the present disclosure and, together with the detailed description and the examples, serve to explain the principles and implementations of the disclosure.

FIG. 1 shows a schematic illustration of a method that is suitable to produce oligonucleotide probes for use in microbial detection arrays.

FIG. 2 shows results of an array hybridization experiment and analysis according to the disclosure. The right-hand column of bar graphs shows the unconditional and conditional log-odds scores for each target genome listed at right. That is, the darker shaded part of the bar shows the contribution from a target that cannot be explained by another, more likely target above it, while the lighter shaded part of the bar illustrates that some very similar targets share a number of probes, so that multiple targets may be consistent with the hybridization signals. The left-hand column of bar graphs shows the expectation (mean) values of the numbers of probes expected to be present given the presence of the corresponding target genome. The larger “expected” score is obtained by summing the conditional detection probabilities for all probes; the smaller “detected” score is derived by limiting this sum to probes that were actually detected. Because probes often cross-hybridize to multiple related genome sequences, the numbers of “expected” and “detected” probes often greatly exceed the number of probes that were actually designed for a given target organism.

FIGS. 3-9 shows results of an array hybridization experiment and analysis similar to FIG. 2 for the indicated target genome.

FIG. 10 shows a plot of intensity distributions for adenovirus target-specific probes and negative control probes in an adenovirus limit of detection experiment at selected DNA concentrations. Hybridization was conducted for 17 hours.

FIG. 11 shows a plot of intensity distributions similar to FIG. 10 at the indicated DNA concentrations. Hybridization was conducted for 1 hour.

### DETAILED DESCRIPTION

According to an embodiment of the present disclosure, methods to obtain a plurality of oligonucleotide probe sequences for detection of one or more targets within a target group are provided.

The term “oligonucleotide” as used herein refers to a polynucleotide with three or more nucleotides. In the present disclosure, oligonucleotides serve as “probes”, often when attached to and immobilized on a substrate or support. The term “polynucleotide” as used herein indicates an organic polymer composed of two or more monomers including nucleotides, nucleosides or analogs thereof. The term “nucleotide” refers to any of several compounds that consist of a ribose or deoxyribose sugar joined to a purine or pyrimidine base and to a phosphate group and that is the basic structural unit of nucleic acids. The term “nucleoside” refers to a compound (such as guanosine or adenosine) that consists of a purine or pyrimidine base combined with deoxyribose or ribose and is found especially in nucleic acids. The term “nucleotide analog” or “nucleoside analog” refers respectively to a nucleotide or nucleoside in which one or more individual atoms have been replaced with a different atom or a with a different functional group. Accordingly, the term “polynucleotide” includes nucleic acids of any length, and in particular DNA, RNA, analogs and fragments thereof.

The term “target” as used herein refers to a genomic sequence of an organism or biological particle such as a virus. Thus a “target sequence” as used herein refers to the genomic sequence of a target organism or particle. In particular, a genomic sequence includes sequences of any nuclear, mitochondrial, and plasmid DNA, as well as any other nucleic acids carried by the organism or particle.

The term “target group” as used herein refers to a group of organisms or viral particles with related genomic sequences. By way of example and not of limitation, a target group can be a viral family or a bacterial family. In particular, a target family comprises the family classification according to the NCBI (National Center for Biotechnology Information) taxonomy tree. A target group can also comprise a viral, bacterial, fungal, or protozoal sequence group classified under a taxonomic node other than family.

Embodiments of the present disclosure are directed to a method to obtain a pan-Microbial Detection Array (MDA) to detect all known viruses (including phage), bacteria, and plasmids and the MDA thus obtained. Family-specific probes are selected for all sequenced viral and bacterial complete genomes, segments, and plasmids. In some embodiments, bacteria are those under the superkingdom Bacteria (eubacteria) taxonomy node at NCBI, and do not include the Archaea. Probes are designed to tolerate some sequence variation to enable detection of divergent species with homology to sequenced organisms. One embodiment of the array of the present disclosure (Version 3 or v3) also contains family-specific probes for all known/sequenced fungi and species-specific probes for human-infecting protozoa and their near neighbors. The probes can then be arranged on suitable substrates to form an array using procedures identifiable by a skilled person upon reading of the present disclosure.

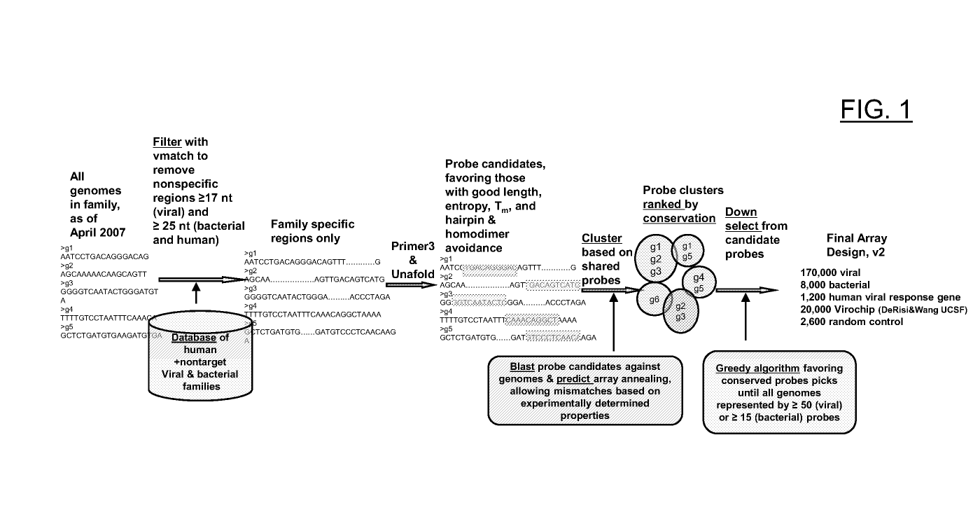

FIG. 1 provides an illustration of a process used to obtain the oligonucleotide probe sequences in accordance with the present disclosure.

An initial genomic collection can be obtained, for example, by downloading a complete bacterial (e.g. eubacteria) and viral genomes, segments, and plasmid sequences from NCBI Genbank, the Integrated Microbial Genomics (IMG) project at the Joint Genome Institute, the Comprehensive Microbial Resource (CMR) at the JC Venter Institute, and The Sanger Institute in the United Kingdom. The sequence data is then organized by family for all organisms or targets. For embodiment of Version 3 (v3) of the array of the present disclosure, all available partial sequences were included in the target sequence collection as well as complete genomes.

It has been shown that the length of longest perfect match (PM) is a strong predictor of hybridization intensity, and that for probes at least 50 nucleotide (nt) long, a PM≦20 base pairs (bp) have signal less than 20% of that with a PM over the entire length of the probe. Therefore, for each target family, regions with perfect matches to sequences outside the target family were eliminated. In particular, a match threshold was identified in accordance with the present disclosure. Using, e.g., the suffix array software vmatch (see reference 6), perfect match subsequences of, e.g., at least 17 nt long present in non-target viral families or, e.g., 25 nt long present in the human genome or non-target bacterial families were eliminated from consideration as possible probe subsequences. Sequence similarity of probes to non-target sequences below this threshold was allowed. As shown later in the present disclosure, such similarity can be accounted for using a statistical log likelihood algorithm, later described. According to an embodiment of the disclosure, from these family-specific regions, probes 50-66 bases long were designed for one family at a time. Candidate probes were generated using, for example, MIT's Primer3 software. See, e.g., Steve Rozen, Helen J. Skaletsky (1998) Primer3.

According to an embodiment of the disclosure, the following Primer3 settings were modified from the default values:

PRIMER_TASK=pick_hyb_probe_only

### PRIMER_PICK_ANYWAY=1

### PRIMER_INTERNAL_OLIGO_OPT_SIZE=55

### PRIMER_INTERNAL_OLIGO_MIN_SIZE=50

### PRIMER_INTERNAL_OLIGO_MAX_SIZE=60

### PRIMER_INTERNAL_OLIGO_OPT_TM=90

### PRIMER_INTERNAL_OLIGO_MIN_TM=80

### PRIMER_INTERNAL_OLIGO_MAX_TM=110

### PRIMER_INTERNAL_OLIGO_MIN_GC=25

### PRIMER_INTERNAL_OLIGO_MAX_GC=75

### PRIMER_NUM_NS_ACCEPTED=0

### PRIMER_EXPLAIN_FLAG=0

### PRIMER_FILE_FLAG=1

### PRIMER_INTERNAL_OLIGO_SALT_CONC=450

### PRIMER_INTERNAL_OLIGO_DNA_CONC=100

### PRIMER_INTERNAL_OLIGO_MAX_POLY_X=4

These settings identify candidate probes in the desired length range, melting temperature (Tₘ) range, GC % range, and without homopolymer repeats longer than 4 (i.e. regions with AAAAA, GGGGG, etc. are not selected as probe candidates).

The above step was followed by Tₘ and homodimer, hairpin, and probe-target free energy (ΔG) prediction using, for example, Unafold (see, e.g., Markham, N. R. & Zuker, M. (2005) DINAMelt web server for nucleic acid melting prediction. Nucleic Acids Res., 33, W57 W581). Homodimers occur when an oligo hybridizes to another copy of the same sequence, and hairpining occurs when an oligo folds so that one part of the oligo hybridizes with another part of the same oligo. According to an embodiment of the disclosure, candidate probes with unsuitable ΔG's, GC % or Tₘ's were excluded as described in reference 8. Desirable range for these parameters was 50≦length≦66, Tₘ≧80° C., 25%≦GC %≦75%, trimer entropy>4.5, ΔG_{homodimer}=ΔG of homodimer formation >15 kcal/mol, ΔGₕₐᵢᵣₚᵢₙ=ΔG of hairpin formation >−11 kcal/mol, and ΔG_{adjusted}=ΔG_{complement}−1.45 ΔGₕₐᵢᵣₚᵢₙ−0.33 ΔG_{homodimer}≦−52 kcal/mol. In some cases, related for example to bacterial probes, an additional minimum sequence complexity constraint was enforced, requiring a trimer frequency entropy of at least 4.5.

More generally, in accordance with the above embodiments, probes with suitable annealing characteristics or preferred binding properties (e.g., polynucleotides from target specific regions with favored thermodynamic characteristics) were selected, in order to remove probes that are likely to bind to non-target sequences, whether the non-target sequence is the probe itself or a low complexity non-specific sequence. If fewer than a user-specified minimum number of candidate probes per target sequence (the specific value of which can depend upon the particular application needs and available number of probes on a particular array platform) passed all the criteria, then those criteria were relaxed to allow a sufficient number of probes per target. In accordance with a relaxation embodiment, candidates that passed the above mentioned first step but failed the above mentioned second step can be allowed. If no candidates passed the first step, then regions passing target-specificity (e.g. family specific) and minimum length constraints can be allowed.

From these candidates, probes were selected in decreasing order of the number of targets represented by that probe (i.e., probes detecting more targets in the family were chosen preferentially over those that detected fewer targets in the family), where a target was considered to be represented if, for example, a probe matched it with at least 85% sequence similarity over the total probe length, and a perfectly matching subsequence of at least 29 contiguous bases spanned the middle of the probe. It should be noted that the perfect-match stretch did not have to be centered, and in fact data gathered by the applicants indicate, in some embodiments, higher probe sensitivity if the match falls toward the 5′ end of the probe (for probes tethered to the solid support at the 3′ end), so long as it extends over the middle of the probe.

For probes that tie in the number of targets represented, a secondary ranking was used to favor probes most dispersed across the target from those probes which had already been selected to represent that target. The probe with the same conservation rank that occurs at the farthest distance from any probe already selected from the target sequence is the next probe to be chosen to represent that target.

In several embodiments, arrays contained probes representing all complete viral genomes or segments associated with a known viral family, with at least 15 probes per target (Table 1). For example, a first exemplary array obtained by applicants (array v1) did not include unclassified targets not designated under a family. On a second example of array obtained by applicants (v2 array), every viral genome or segment was represented by at least 50 probes, totaling 170,399 probes, except for 1,084 viral genomes that were not associated under a family-ranked taxonomic node (“nonConforming sequences”). These had a minimum of 40 probes per sequence totaling 12,342 probes. There were a minimum of 15 probes per bacterial genome or plasmid sequence, totaling 7,864 probes on the v2 array. Bacterial genomes that were not associated under a family-ranked taxonomic node were not included in the v2 array design.

TABLE 1
Summary of v1 and v2 array design - Probe Counts

| Number of Probes | Probe Description |
|---|---|
| Version 1 | |
| 36497 | Viral detection probes (15 probes/target |
| | from each taxonomic family) |
| 20736 | Wang, deRisi Virochip probes |
| 1278 | human viral response genes |
| 3000 | random controls |
| Version 2 | |
| 170399 | Viral probes (50 probes/target from each |
| | taxonomic family) × 2 replicates |
| 12342 | nonConforming viruses (not associated w/ |
| | taxonomic family, 40 probes/target) |
| 7864 | bacterial probes (15 probes/target) |
| 20736 | Wang, deRisi Virochip probes |
| 1278 | human viral response genes |
| 2651 | random controls |

On both arrays v1 and v2, as controls for the presence of human DNA/mRNA from clinical samples, 1,278 probes to human immune response genes were designed. For targets, the genes for GO:0009615 (“response to virus”) were downloaded from the Gene Ontology AmiGO website (http://amigo.geneontology.org), filtering for Homo sapiens sequences. There were 58 protein sequences available at the time (Jul. 12, 2007), and from these, the gene sequences of length up to 4× the protein length were downloaded from the NCBI nucleotide database based on the EMBL ID number, resulting in 187 gene sequences. Fifteen probes per sequence were designed for these using the same specifications as for the bacterial and viral target probes.

To assess background hybridization intensity, ˜2,600 random control probe sequences were designed that were length and GC % matched to the target probes on array v1 or v2. These had no appreciable homology to known sequences based on BLAST similarity.

In addition, 21,888 probes from the Virochip version 3 from University of California San Francisco (see references 3, 21, 22, 23) were included on array v1 and v2.

In several embodiments including further exemplary arrays obtained by applicants (arrays v3.1, v3.2, v3.3, and v3.4), sequence data was downloaded as summarized in Table 2 for all viral, bacterial, and fungal sequences, and species of protozoa that infect humans and near neighbors of those protozoa species. All sequences from the LLNL KPATH and NCBI Genbank databases were included, whether it represented complete genomes, partial sequences, genes, noncoding fragments, etc.

In order to reduce the number of redundant viral sequences, cd-hit (see reference 26) was used to cluster the sequences within each group or family of viral sequences into clusters sharing 98% identity, and using only the longest sequence representative from each cluster for conserved probe design. This reduced the number of nonredundant viral targets by ˜70% compared to the full set with numerous duplicate and near-duplicate sequences.

As in other embodiments, the vmatch software (see reference 6) can be used as described above, to eliminate non-unique regions of a target group (e.g. a viral or bacterial family) relative to other families and kingdoms, or species for the case of protozoa. Bacterial and viral probes were designed to be unique relative to one another and the human genome, but were not checked for uniqueness against fungal and protozoa sequences. Uniqueness against sequences in the same kingdom was not required for groups without family classification. Fungal and protozoa sequences were checked against one another as well as against human, viral, and bacterial genomes for uniqueness. From the unique regions, a candidate pool of probes was designed that passed Tₘ, length, GC %, entropy, hairpin, and homodimer filters as for previously described embodiments, relaxing these constraints where necessary to obtain sufficient numbers of probes per target.

Some sequences did not contain enough unique subsequences from which to design probes, for example, many rRNA sequences are conserved across different families or even kingdoms so are not appropriate for family identification, and probes for these were not designed. Probes conserved within a family or within subclades of a family (e.g. genus, species, etc.), yet still unique relative to other families and kingdoms, were selected as described above for array v2, favoring probes conserved within a family or other grouping (e.g. a virus group without family classification or a protozoa species). That is, Applicants selected probes in decreasing order (i.e. probes detecting more targets in the family were chosen preferentially over those that detected fewer targets in the family) of the number of targets represented by that probe, where a target was considered to be represented if a probe matched it with at least 85% sequence similarity over the total probe length, and a perfectly matching subsequence of at least 29 contiguous bases spanned the middle of the probe.

It should be noted that probes are unique relative to other non-target families and kingdoms, but are conserved to the extent possible within the target group (e.g. family grouping or in the case of protozoa, species group). The conserved, or “discovery” probes are aimed to detect novel unsequenced organisms that may be likely to share the same conserved regions as have been observed in previously sequenced organisms.

According to further embodiments of the present disclosure, probes can be chosen by other alternative criteria, for example, by selecting probes chosen from dispersed positions in each target sequence to represent regions in different parts of each genome, which could be useful, for example, in detecting chimeric sequences. Or another criteria could be to select probes chosen to be shared across as many sequences as possible, regardless of family specificity, so that probes shared across multiple families and even kingdoms would be preferred. The above criteria are based on the fact that evolutionarily-related organisms contain sufficient nucleotide sequence conservation, in at least some genomic region(s), to be exploited at the desired taxonomic resolution level.

Several array designs of conserved probes were created with different probe densities, differing in the number of probes per target sequence, as indicated in the Table 2. Total probe counts (Table 3) indicate those remaining after removing duplicate probes. The design platform in Table 3 includes the company and the number of probes (probe density) on the array, although the list of platforms and companies is not an exclusive list. These are the platforms that that the applicants have worked with experimentally. The NimbleGen® 3×720K array by Roche can test 3 samples at a time with 720,000 probes, as it is essentially the 2.1 M probe density array divided into 3 areas.

TABLE 2
Array versions 3.1, 3.2, 3.3., and 3.4 - Probe count breakdown

| | Target Type | Probes per sequence (pps) |
|---|---|---|
| MDA v3.1 | | |
| 893961 | Bacteria Family | 30 pps |
| 263586 | Bacteria Family | 30 pps |
| | Unclassified | |
| 346957 | Viral Family probes | 30 pps |
| 16686 | Viral Family Unclassified | 30 pps |
| 1875 | SFBB (novel sequences | Tiled adjacent, no overlap between probes |
| | from UCSF Blood Systems | |
| | Research Institute) | |
| 157050 | Fungal probes | 5 pps |
| 137939 | Protozoa probes | 5 pps |
| 1833 | Additional Hemorrhagic | |
| | fever virus probes, same as | |
| | MDA v2 | |
| 3438 | random controls (Len and | |
| | GC distribution matching | |
| | census and design3 MDA | |
| | probes) | |
| 1802110 | Total | MDA High Density Probes |
| MDA v3.2 | | |
| and v3.3 | | |
| 222574 | Bacteria Family | 10 pps for complete genomes and plasmids in every |
| | | family; plus 10 pps for genes and fragments in 248 |
| | | smaller families; plus 1 pps for genes and sequence |
| | | fragments in the 32 families with the most sequence |
| | | data |
| 49016 | Bacteria Family | 5 pps |
| | Unclassified | |
| 137855 | Viral Family probes | 10 pps for all sequences, both complete and |
| | | fragments |
| 5747 | Viral Family Unclassified | 10 pps for all sequences, both complete and |
| | | fragments |
| 1875 | SFBB | Tiled across each sequence with 0 overlap, i.e. each |
| | | base has probe coverage of 1. Unpublished sequence |
| | | targets of novel viruses provided by Eric Delwart's |
| | | group at the Blood Systems Research Institute, |
| | | University of California, San Francisco, CA (abbrev |
| | | SFBB = SF Blood Bank) |
| 157050 | Fungal probes | 5 pps |
| 137939 | Protozoa probes | 5 pps |
| 1833 | Additional Hemorrhagic | |
| | fever virus probes, same as | |
| | MDA v2 | |
| 3469 | random controls (Len and | |
| | GC distribution matching | |
| | census and design1 MDA | |
| | probes) | |
| 713743 | Total | MDA Medium Density Probes |
| v3.4 | | |
| 161451 | Bacteria Family | 10 pps for complete genomes and plasmids in every |
| | | family; plus 10 pps for genes and fragments in 248 |
| | | smaller families; |
| 49016 | Bacteria Family | 5 pps |
| | Unclassified | |
| 137855 | Viral Family probes | 10 pps for all sequences, both complete and fragments |
| 5747 | Viral Family Unclassified | 10 pps for all sequences, both complete and fragments |
| 1875 | SFBB | Tiled across each sequence with 0 overlap, i.e. each |
| | | base has probe coverage of 1 |
| 1833 | Additional Hemorrhagic | |
| | fever virus probes, same as | |
| | MDA v2 | |
| 2562 | random controls | |
| 357532 | Total | MDA Low Density Probes |

TABLE 3
Array versions 3.1, 3.2. 3.3, and 3.4 - Total probe counts

| | | Array Platform | | MDA |
|---|---|---|---|---|
| Probe | | (# indicates | | Ver- |
| Counts | | Probe density) | Probes included | sion |
| 2062997 | Total | Nimblegen 2.1M | MDA High Density | 3.1 |
| | | | Probes + Census probes | |
| 937649 | Total | Agilent 1M | MDA Medium Density | 3.2 |
| | | | Probes + Census probes | |
| 713743 | Total | NimbleGen3x720K | MDA Medium Density | 3.3 |
| | | | Probes | |
| 357532 | Total | Nimblegen 388K | MDA Low Density | 3.4 |
| | | | Probes | |

Probe counts represent numbers after removing duplicate probes, which may occur between census and discovery probes or between family unclassified and family classified viruses (or bacteria).

“Conserved” probes are probes conserved across multiple sequences from within a family or other (e.g. protozoa species, or family-unclassified viral group) target set, but not conserved across families or kingdoms. Such probes aim to detect known organisms or discovery novel organisms that have not been sequenced which possess some sequence homology to organisms that have been sequenced, particularly in those regions found to be conserved among previously sequenced members of that family or other target group. These conserved probes may identify an organism to the level of genus or species, for example, but may lack the specificity to pin the identification down to strain or isolate.

In several embodiments, an alternative method of selecting probes was used in order to select the least conserved, that is, the most strain or sequence specific probes. These probes were termed “census probes”. Such census probes, aim to fill the goal of providing higher level discrimination/identification of known species and strains, but may fail to detect novel organisms with limited homology to sequenced organisms. Census probes were designed to provide greater discrimination among targets to facilitate forensic resolution to the strain or isolate level. As in the foregoing description and similar to other embodiments, a greedy algorithm was employed, however in this case the probes matching the fewest target sequences were favored. Probes were selected from the pool of probe candidates passing the Tₘ, length, GC %, entropy, hairpin, and homodimer filters when possible.

As also mentioned above, these constraints were relaxed if necessary to obtain sufficient probes per sequence for targets with adequate unique regions. For every target sequence, probes were selected in ascending order of the number of targets represented by that probe, where a target was considered to be represented if a probe matched it with, for example, at least 85% sequence similarity over the total probe length, and, for example, a perfectly matching subsequence of at least 29 contiguous bases spanned the middle of the probe. By ascending order, it is meant that probes were sorted in increasing order of the number of targets each represents, and for each target sequence probes were picked from the list in order of those that detected the fewest other target sequences. According to some embodiments, probes were continually selected for a target until at least suitable 10 probes per sequence were identified. Due to the large number of Orthomyxoviridae sequences, only 5 probes per sequence were included for this family. In this way, the most sequence-specific probes were selected, accumulating probes in order of sequence-specificity until the desired number of probes per target was obtained.

Census probes were designed for all the viral and bacterial complete genomes, segments, and plasmids, as indicated in Table 4. Viral sequences were not clustered using cd-hit as in the foregoing description of conserved probes, since it was desired that the census probes discriminate every isolate, if possible, even if those isolates had more than 98% identity. Census probes were also designed for sequence fragments for those bacterial families with less available sequence data, although not for the 32 families with the most available sequence data since they were already so well-represented by the probes for the large amount of complete sequences available and the additional probes representing the fragmentary and partial sequences was thought to be unnecessary for the goal of censusing for strain discrimination.

TABLE 4
Census Probe Counts

| | | |
|---|---|---|
| 307086 | Bacteria Family | 10 pps, whole genomes for all fami- |
| | | lies, fragments for 248 smaller fami- |
| | | lies, but not fragments for 32 families |
| | | with the most sequence data |
| 1691 | Bacteria Family | 10 pps |
| | Unclassified | |
| 84597 | Viral Family probes | 10 pps |
| | except Orthomyxoviridae | |
| 9934 | Viral Family | 10 pps |
| | Unclassified | |
| 15118 | Orthomyxoviridae | 5 pps |
| 418363 | Total | |

In several embodiments, a multiplex array was designed using the oligonucleotide probes designed according to the method herein disclosed. In particular, the NimbleGen platform supports a 4-plex configuration. This uses a gasket to divide a slide into 4 individual subarrays, enabling the testing of 4 samples at a time on a single slide and lowering the cost per sample. Up to 72,000 probe sequences can be tiled within each subarray.

To take advantage of this configuration, a modified version v2 of the array according to the present disclosure was built with 70,916 unique probe sequences. Array v2 as described above has 215,270 probe sequences, representing each virus genome or segment by at least 50 probes. In a smaller v2.1 array, each virus genome or segment is represented by 10-20 probes, as indicated in Table 5. The same process was used to downselect from the candidate pool of probes as was described in paragraph 0033, as before favoring probes that were more conserved within the target group and breaking ties by picking the most distant probe in a target genome from other probes that were already selected for that target, building up the total until all viral genomes and segments were represented by the user-specified (10 or 20) number of probes. The same bacterial probes were used as on the array v2, and the probes from the Virochip and human viral response genes were omitted.

TABLE 5
Reduced probe set multiplex array v2.1

| Number of | Probes per | |
|---|---|---|
| probes | sequence | Target Sequences |
| 48893 | 20 | All Viral families except Orthomyxoviridae and family |
| | | unclassified complete viral genomes and segments |
| 7777 | 10 | Segments in the Orthopox family |
| 2972 | 10 | Family unclassified viral genomes and complete segments |
| 7864 | 15 | Bacterial genomes and plasmids |
| 3410 | — | Random controls with GC % and length distribution matched |
| | | to target probes |
| 70916 | | Total |

Further embodiments of the present disclosure also provide: 1) methods of classifying an oligonucleotide probe sequence as detected or undetected in a biological sample; 2) methods of predicting the conditional probability of detecting a probe sequence, given the presence of a target of known nucleotide sequence in a biological sample; 3) methods of predicting likelihood of presence of a target of known nucleotide sequence in a biological sample; 4) selection methods for selecting, from a list of candidate target sequences of known nucleotide sequence, a target sequence most likely to be present in a biological sample; and 5) selection methods for selecting, from a list of candidates, a set of targets whose presence in a biological sample would collectively provide the best explanation for observed detected and undetected probes on an array.

In several embodiments, microarrays are constructed by synthesizing oligonucleotide molecules (denoted henceforth as “oligos”) with the required probe sequences directly upon a solid glass or silica substrate. In other embodiments, oligos are synthesized in a separate process, and then adhered to the substrate. Regardless of the technology used to produce the oligos, an array is partitioned into regions called “features”, each of which is assigned a single known probe sequence. Array construction results in the placement of a large number (on the order of 10⁵ to 10⁷) of identical oligos, all having the assigned probe sequence, within each feature.

In several embodiments, negative control probes having randomly generated sequences are incorporated into the array design. The length and percent GC content distributions of the negative control probe sequences are chosen for each array design to be similar to that of the microbial target probe sequences. Between 1,000 and 10,000 negative control probes are included in each array design. The presence of negative control probes allows estimation of the expected distribution of intensities for probes that have no significant similarity to any target DNA sequence in a biological sample. The method disclosed below for classification of probe sequences as detected or undetected requires the presence of negative control probes.

In all embodiments, probe intensity data is generated for each biological sample to be analyzed, according to one of several protocols in common use in the field of this invention. In a typical embodiment, fluorescently labeled target DNA synthesized from templates extracted from a biological sample is incubated for several hours on an array comprising a plurality of probes, to allow for hybridization of target DNA to any probes of the array having sequences similar to those of the target DNA. This procedure produces a variable number of target-probe hybridization products for each probe sequence. Following the hybridization step, the array is washed to remove unhybridized target DNA. A standard microarray scanner is then used to measure an aggregate fluorescence intensity value for each feature on the array. The intensity measured for each feature increases according to the number of target-probe hybridization products involving probes of the sequence assigned to that feature.

In several embodiments of the present disclosure, a method for classifying a target oligonucleotide probe sequence as detected or undetected in a biological sample is provided. The method is as follows: A minimum threshold intensity is determined for each array, as some percentile of the observed distribution of intensities for the negative control probes. Typically the 99^{th} percentile is used, but other values may be selected at the experimenter's discretion. The target probe sequence is then classified as detected if its associated feature intensity exceeds the threshold intensity, and as undetected if not. In several embodiments, this classification determines the value of a binary response variable Y, used in further analysis: 1 if probe i is detected and 0 if not.

Further embodiments provide methods of estimating the conditional detection probability for a particular probe sequence, given the presence of some target of known nucleotide sequence in a biological sample analyzed by a microarray. These methods are based on statistical models for the probability of classifying a probe sequence as detected in a sample, as a function of the nucleotide sequences of the probe itself and of the “most similar” portion of the target sequence. The “most similar” portion of the target sequence is identified by performing a BLAST search, using the probe and target as query and subject sequences respectively, and choosing the target subsequence (if any) having the highest-scoring gap-free alignment. If BLAST finds no alignments exceeding some minimum score threshold, the probe is considered to have no significant similarity to the target sequence; in this case the detection probability is estimated as a function of the probe sequence only.

Estimates of detection probability require choosing a statistical model, and performing a calibration step once for each microarray platform to estimate the parameters of the model. In one embodiment, the model contains four predictor covariates, three of which are determined from the highest-scoring BLAST alignment of probe i to target j. These include the BLAST bit score Bᵢⱼ, and the position Qᵢⱼ of the start of the alignment within the probe sequence. Both of these variables are obtained directly from the BLAST results. The third covariate is an approximate predicted melting temperature Tᵢⱼ, computed from the aligned nucleotides according to the formula Tᵢⱼ=69.4° C.+(41.0 N_{GC}−600.0)/L, where L is the length of the alignment and N_{GC} is the number of G and C nucleotides that are aligned to their complements. The fourth covariate, Sᵢ, depends on the probe sequence only. Sᵢ is the entropy of the trimer frequency table of the probe sequence, which serves as a measure of sequence complexity. It is obtained from the numbers of occurrences n_{AAA}, n_{AAC}, . . . , n_{TTT} of the 64 possible trimers (3-nucleotide subsequences) within the probe sequence, divided by the total number of trimers, yielding the corresponding frequencies f_{AAA}, . . . , f_{TTT}. The entropy is then given by:

$${S}_{i} = {\sum }_{t ∷ {f}_{t} \neq 0} - {f}_{t} {log}_{2} {f}_{t} \qquad ( 1 )$$

where the sum is over the trimers t with fₜ≠0. Applicants have found empirically that the trimer entropy is a good predictor of non-specific hybridization; probes with low entropy (and thus low sequence complexity) resulting from direct or tandem repeats are more likely to give strong detection signals regardless of the target sequence.

A statistical model that estimates the detection probability for probe i, conditional on the presence of target j, is then described in terms of these four covariates by the following equations:

log it(P(Yᵢ=1|target j is present))=a₀+a₁Sᵢ+a₂Tᵢⱼ+a₃Bᵢⱼ+a₄Qᵢⱼ (2)

log it(P(Yᵢ=1|target j is absent))=a₀+a₁Sᵢ (3)

In equations (2) and (3), log it(x)=log [x/(1−x)] is the log-odds transformation function, and Yᵢ is the binary response variable indicating whether probe i was classified as detected. The parameters a₀ through a₄ are determined at calibration time, by performing several array hybridizations to individual targets with known genome sequences, measuring the probe intensities, classifying probes as detected or undetected, computing the covariates for all probes, and then fitting the model parameters by standard logistic regression methods. Given a set of fitted parameters and covariates computed for probe i and target j, the conditional detection probability is described by the following equation:

$$P ( {Y}_{i} = 1 \vert {X}_{j} ) = \frac{1}{1 + {e}^{- ( {a}_{0} + {a}_{1} {S}_{i} + {X}_{j} ( {a}_{2} {T}_{ij} + {a}_{3} {B}_{ij} + {a}_{4} {Q}_{ij} ) )}} \qquad ( 4 )$$

where Xⱼ is an indicator variable, with value 1 if target j is present and 0 if not.

Another embodiment of the present disclosure provides an alternative method for predicting conditional detection probabilities. This method is based on a logistic model, with two covariates in place of the four used in the previously described method. The two covariates are the trimer entropy Sᵢ described above, and the free energy ΔGᵢⱼ predicted for the highest-scoring probe-target alignment. The free energy is predicted from the aligned probe and target subsequences, using the nearest-neighbor stacking energy model described in reference 27, with an optional position-specific weight factor. The model is described by the equations:

log it(P(Yᵢ=1|target j is present))=b₀+b₁Sᵢ+b₂ΔGᵢⱼ (5)

log it(P(Yᵢ=1|target j is absent))=b₀+b₁Sᵢ (6)

where b₀, b₁ and b₂ are model parameters to be fitted at calibration time, and other variables are as described previously. In all other respects, this method is the same as the previously described method for estimating detection probabilities. The resulting conditional detection probability is described by the equation:

$$P ( {Y}_{i} = 1 \vert {X}_{j} ) = \frac{1}{1 + {e}^{- ( {b}_{0} + {b}_{1} {S}_{i} + {b}_{2} {X}_{j} Δ {G}_{ij} )}} \qquad ( 7 )$$

Further embodiments provide methods of predicting the likelihood of presence of a particular target, of known nucleotide sequence, in a biological sample. In several embodiments, target DNA from the biological sample is hybridized to an array, fluorescence intensities are measured for each probe sequence, and probe sequences are classified as detected or undetected using one of the methods described above. Let Yᵢ be the binary response variable indicating whether probe i was classified as detected (1) or undetected (0). The probe responses are used to compute a likelihood function, under the assumption that the responses for different probes are conditionally independent of one another, given the presence or absence of specified target j. If Y represents the vector of probe response variables Yᵢ, the likelihood of target j being present in the sample (Xⱼ=1) or absent (Xⱼ=0) given the observed response is given by the equation:

$$L ( {X}_{j} ; Y ) = {\prod }_{i ∷ {Y}_{i} = 1} P ( {Y}_{i} = 1 \vert {X}_{j} ) {\prod }_{i ∷ {Y}_{i} = 0} P ( {Y}_{i} = 0 \vert {X}_{j} ) \qquad ( 8 )$$

where P(Yᵢ=1|Xⱼ) is given by equation (4) or (7), and P(Yᵢ=0|Xⱼ)=1−P(Yᵢ=1|Xⱼ).

In several embodiments, a single target selection method is provided for choosing, from a list of candidate targets of known nucleotide sequence, the target that is most likely to be present in a biological sample. After hybridizing the sample to an array, scanning the array and classifying probe sequences as detected or undetected, the relative likelihoods of target presence versus absence are computed for each candidate target by evaluating the aggregate log-odds score:

$$log \frac{L ( {X}_{j} = 1 ; Y )}{L ( {X}_{j} = 0 ; Y )} = {\sum }_{i ∷ {Y}_{i} = 1} log \frac{P ( {Y}_{i} = 1 \vert {X}_{j} = 1 )}{P ( {Y}_{i} = 1 \vert {X}_{j} = 0 )} + {\sum }_{i ∷ {Y}_{i} = 0} log \frac{P ( {Y}_{i} = 1 \vert {X}_{j} = 1 )}{P ( {Y}_{i} = 1 \vert {X}_{j} = 0 )} \qquad ( 9 )$$

To choose the most likely target, an aggregate log-odds score is computed for each candidate target, and the target with the maximum score is selected.

In several embodiments of the present disclosure, a multiple target selection method is provided to select a combination of targets whose presence in a biological sample would best explain the observed pattern of probe responses on an array hybridized to the sample. The selection method employs a greedy algorithm to find a local maximum for the log-likelihood. The algorithm is initialized by placing all candidate targets in an “unselected” list U and an empty “selected” list S. The following steps are then iterated until the algorithm terminates:
1. Compute the conditional log-odds score for each target jεU:

$${\sum }_{i ∷ {Y}_{i} = 1} log \frac{P ( {Y}_{i} = 1 \vert {X}_{j} = 1 , {X}_{k} = 1 ∀ k ∈ S )}{P ( {Y}_{i} = 1 \vert {X}_{j} = 0 , {X}_{k} = 1 ∀ k ∈ S )} + {\sum }_{i ∷ {Y}_{i} = 0} log \frac{P ( {Y}_{i} = 0 \vert {X}_{j} = 1 , {X}_{k} = 1 ∀ k ∈ S )}{P ( {Y}_{i} = 0 \vert {X}_{j} = 0 , {X}_{k} = 1 ∀ k ∈ S )} \qquad ( 10 )$$

When this step is performed for the first time, the selected list S will be empty, so the computed log-odds score for each target will not be conditioned on the presence of any other targets. Store this “initial” log-odds score for each target, for later display.
2. Choose the target that yields the largest value of the score, remove it from list U, and add it to the selected list S. Store the value of this “final” score for each selected target.
3. Repeat steps 1 and 2 until there is no target in U that yields a positive value for the conditional log-odds score.
   To compute the conditional probabilities in equation (10), the method uses the approximation:

$$P ( {Y}_{i} = 0 \vert X ) \approx {\prod }_{j ∷ {X}_{j} = 1} P ( {Y}_{i} = 0 \vert {X}_{j} = 1 ) \qquad ( 11 )$$

where X represents a vector of binary Xₖ values. In other words, it assumes that the probability of obtaining an undetected response for a probe depends only on the set of targets that are assumed to be present, and that it can be estimated by multiplying the probabilities conditioned on the presence of the individual targets. The conditional detection probabilities are given by:

$$P ( {Y}_{i} = 1 \vert X ) \approx 1 - {\prod }_{j ∷ {X}_{j} = 1} P ( {Y}_{i} = 0 \vert {X}_{j} = 1 ) \qquad ( 12 )$$

The output of the multiple target selection method is an ordered series of target genomes predicted to be present, together with of the initial and final scores for each selected target. The initial score is the log-odds from the first iteration; that is, the log-likelihood of the target being present assuming that no other targets are present. The final score for the n^{th} selected target is the log-odds conditional on the presence of the first through the (n−1)^{st} selected targets.

Conditioning on the previously selected targets has the effect of subtracting the contributions from the associated probes from the log-likelihood. Therefore, the multiple target selection algorithm can be visualized as an iterative process that first chooses the target that explains the greatest number of probes with positive detection signals, while minimizing the number of undetected probes that would also be expected to be present; then chooses the target that explains the largest number of probes not already explained by the first target, and so on until as many detected probes as possible are explained.

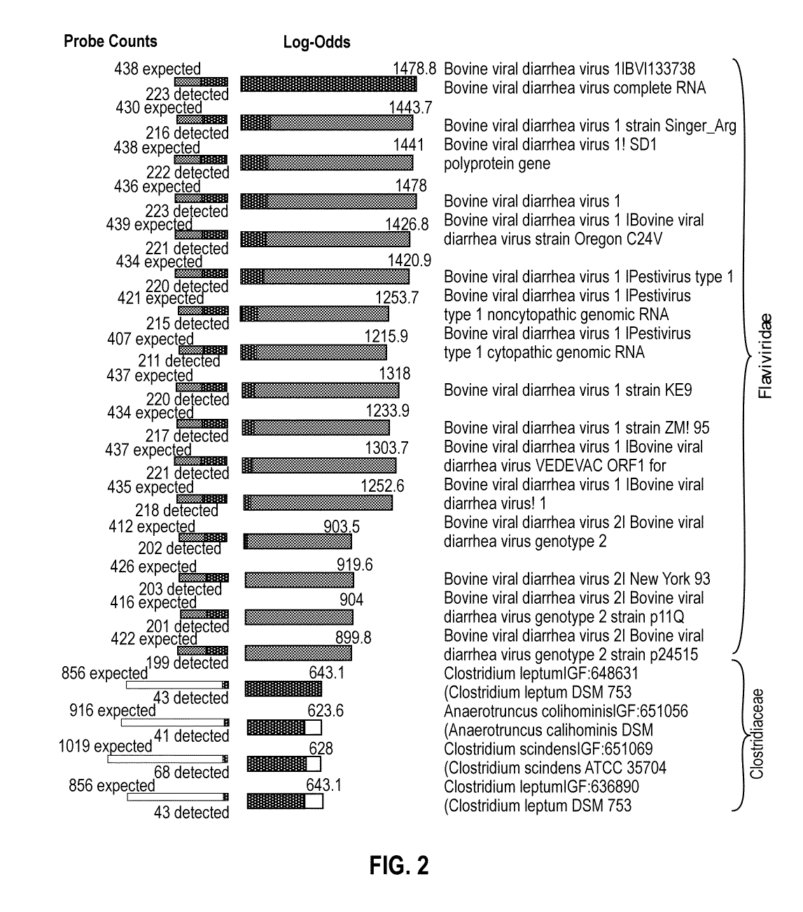

An example of the analysis results is shown in FIG. 2. The right-hand column of bar graphs shows the initial and final log-odds scores for each target genome listed at right. The initial log-odds is the larger of the two scores; thus the lighter and darker-shaded portions represent the initial and final scores respectively. That is, the darker shade on the left part of the bar shows the contribution from a target that cannot be explained by another, more likely target above it, while the lighter shaded part on the right of the bar illustrates that some very similar targets share a number of probes, so that multiple targets may be consistent with the hybridization signals. Targets are grouped by taxonomic family, indicated by the bracket to the side; they are listed within families in decreasing order of final log-odds scores.

The left-hand column of bar graphs shows the expectation (mean) values of the numbers of probes expected to be present given the presence of the corresponding target genome. The larger “expected” score is obtained by summing the conditional detection probabilities for all probes; the smaller “detected” score is derived by limiting this sum to probes that were actually detected. Because probes often cross-hybridize to multiple related genome sequences, the numbers of “expected” and “detected” probes often greatly exceed the number of probes that were actually designed for a given target organism. The probe count bar graphs are designed to provide some additional guidance for interpreting the prediction results.

In summary, in accordance with embodiments of the present disclosure, probes were selected to avoid sequences with high levels of similarity to human, bacterial and viral sequences not in the target family; low levels of sequence similarity across families were allowed selectively, on the basis of a statistical model predicting probe intensity from the similarity score, approximate melting temperature and sequence complexity. Favoring more conserved probes within a family enabled us to minimize the total number of probes needed to cover all existing genomes with a high probe density per target, enhancing the capability to identify the species of known organisms and to detect unsequenced or emerging organisms. Strain or subtype identification was not a goal of the MDA discovery probe design, although the ability of MDA v1, v2, v3.3, and v3.4 to discriminate between strains of certain organisms was an unexpected result of combining signals from multiple probes. The goal of the census probes on MDA v3.1 and v3.2 was to discriminate between strains or subtypes, so the combination of signals from both the conserved “discovery” probes and the census probes should reinforce and improve strain discrimination.

In accordance with some embodiments, probes were sufficiently long (50-66 bases) to tolerate some sequence variation (see reference 8), although slightly shorter than the 70-mer probes used on previous arrays (see references 4, 14 and 23) because of the additional synthesis cycles, and therefore cost, of making 70-mers on the NimbleGen platform. Long probes improve hybridization sensitivity and efficiency, alleviate sequence-dependent variation in hybridization, and improve the capability to detect unsequenced microbes. Probes were selected from whole genomes, without regard to gene locations or identities, letting the sequences themselves determine the best signature regions and preclude bias by pre-selection of genes. Applicants designed a version 1 (v1) with 36,000 distinct probe sequences for viruses (at least 15 probes per viral sequence), and then designed a version 2 (v2) that included 170,000 probe sequences for viruses (at least 50 probes/sequence) and 8,000 probe sequences for bacteria (at least 15 probes per sequence), and included the ViroChip v3 (see reference 23) probes for comparison. Arrays were built at Lawrence Livermore National Laboratory (LLNL) using a NimbleGen Array Synthesizer (see reference 19). Applicants hybridized the arrays to a number of samples, including clinical fecal, sputum, and serum samples. In blinded clinical samples containing multiple viruses and bacteria and in known (spiked) mixtures of DNA and RNA viruses, the MDA has been able to detect viruses and bacteria as confirmed by PCR or culture.

In addition, a statistical method has been described that is based on likelihood maximization within a Bayesian network model. It incorporates a probabilistic model of DNA hybridization based on probe-target similarity scores and probe sequence complexity, with parameters fitted to experimental data from pure viral and bacterial samples with sequenced genomes. To accurately determine the organism(s) responsible for a given array result, the pattern of both present and absent probe signals is taken into account (see reference 8).

### EXAMPLES

The arrays, methods and systems of several embodiments herein described are further illustrated in the following examples, which are provided by way of illustration and are not intended to be limiting. A person skilled in the art will appreciate the applicability of the features described in detail for methods.

### Example 1

### Sample Preparation and Microarray Hybridization

DNA microarrays were synthesized using the NimbleGen Maskless Array Synthesizer at Lawrence Livermore National Laboratory as described in reference 8. Adenovirus type 7 strain Gomen (Adenoviridae), respiratory syncytial virus (RSV) strain Long (Paramyxoviridae), respiratory syncytial virus strain B1, bluetongue virus (BTV) type 2 (Reoviridae) and bovine viral diarrhea virus (BVDV) strain Singer (Flaviviridae) were purchased from the National Veterinary lab and grown at LLNL. Purified DNA from human herpesvirus 6B (HHV6B) (Herpesviridae) and vaccinia virus strain Lister (Poxyiridae) were purchased from Advanced Biotechnologies (Maryland, Va.). Eleven blinded viral culture samples were received from Dr. Robert Tesh's lab at University of Texas Medical Branch at Galveston (UTMB). The viral cultures were sent to LLNL in the presence of Trizol reagent.

After treatment with Trizol reagent, RNA from cells was precipitated with isopropanol and washed with 70% ethanol. The RNA pellet was dried and reconstituted with RNase free water. 1 μg of RNA was transcribed into double-strand cDNA with random hexamers using Superscript™ double-stranded cDNA synthesis kit from Invitrogen (Carlsbad, Calif.). The DNA or cDNA was labeled using Cy-3 labeled nonamers from Trilink Biotechnologies and 4 μg of labeled sample was hybridized to the microarray for 16 hours as previously described (see reference 8). Clinical samples that had been extracted and partially purified using Round A and Round B protocols (see reference 23) were obtained from Dr. Joseph DeRisi's laboratory at University of California, San Francisco (UCSF). The samples were amplified for an additional 15 cycles to incorporate aminoallyl-dUTP and labeled with Cy3NHS ester (GE Healthcare (Piscataway, N.J.). The labeled samples were hybridized to NimbleGen arrays.

### Example 2

### Testing on Pure and Mixed Samples of Known Viruses for Array v1

Several of the viruses of Example 1 (adenovirus type 7, RSV, and BVDV) were hybridized on array v1 in single virus hybridization experiments and each was detected by array v1 (data not shown). Several mixtures of both RNA and DNA viruses were also tested (Table 6). PCR primers used to detect or confirm various samples before or after testing samples on the arrays of the present disclosure are provided in Table 9.

TABLE 6
Results of initial tests on array v1.

| Mixture tested | Detected | Additionally detected |
|---|---|---|
| Adenoviral type 7 strain Gomen | Yes | Human endogenous retrovirus |
| Respiratory syncytial virus strain Long | Yes | K113 |
| Bovine viral diarrhea type 1 strain Singer | Yes | Leek yellow stripe potyvirus |
| Respiratory syncytial virus strain B1 | Yes | none |
| Bluetongue virus type 2 | Yes | |
| | (segments | |
| | 2, 6, 8, 9, 10) | |
| Human herpesvirus 6B | Yes | Human endogenous retrovirus |
| Vaccinia virus strain Lister | Yes | K113 |
| Respiratory syncytial virus strain B1 | Yes | Influenza A segment 8 |
| Bluetongue virus type 2 | Yes | |
| | (segments | |
| | 2, 6, 7, 8, 9, 10) | |

All spiked species from Table 6 were detected in the mixture, including most of the segments of BTV. Strain discrimination was not expected, since probes were designed from regions conserved within viral families. Nevertheless, the highest scoring targets in the single virus experiments with adenovirus, BVDV, vaccinia and HHV 6B were in fact the strains hybridized to the arrays. Human endogenous retrovirus K113 was also detected in two of the three mixtures, possibly derived from host cell DNA.

For three particular samples tested, spiked strain identities were compared with those predicted by analyzing either 1) only the LLNL probes versus 2) analyzing only the Virochip probes that were also included on the MDA. The LLNL probes identified the correct Gomen strain of human adenovirus type 7 while the Virochip probes identified the correct species but the incorrect NHRC 1315 strain. In another example, when RSV Long group A (an unsequenced strain) was hybridized to the array, the related RSV strain ATCC VR-26 was predicted by MDA probes, but the Virochip probes failed to detect any RSV strain. For the detection of BVD Singer strain, both LLNL and Virochip probes were able to predict the exact strain hybridized.

### Example 3

### PCR to Confirm Microarray Results

Clinical samples from the DeRisi laboratory (Example 1) were tested by PCR to confirm the microarray results (Example 2). PCR primers were designed using either the KPATH system (see reference 20) or based on the probes that gave a positive signal for the organism identified as present, and the primer sequences are proved as supplementary information. PCR primers were synthesized by Biosearch Technologies Inc (Novato, Calif.). 1 μL of Round B material was re-amplified for 25 cycles and 2 μL of the PCR product was used in a subsequent PCR reaction containing Platinum Taq polymerase (Invitrogen), 200 mM primers for 35 cycles. The PCR condition is as follows: 96° C., 17 sec, 60° C., 30 sec and 72° C., 40 sec. The PCR products were visualized by running on a 3% agarose gel in the presence of ethidium bromide.

### Example 4

### False Negative Error Rates were Estimated for the v1 Array

To further analyze results of array v1 tests as described in Example 2, false negative error rates were estimated for the v1 array. False negative error rates were estimated for experiments in which some or all of the viruses in the sample had known genome sequences (Table 7), and for probes that met Applicants' design criteria (85% identity and a 29 nt perfect match to one of the target genome sequences). The RSV and BTV probes were excluded from this estimate, as sequences were not available for the exact strains used in the experiments. All 128 selected probes had signals above the 99^{th} percentile detection threshold, yielding a zero false negative error rate.

TABLE 7
True positive/false negative counts for probes
in MDA v1 tests with sequenced viruses.

| | Number | | | Percent |
|---|---|---|---|---|
| | of PM | TP | FN | FN error |
| Target | probes | probes | probes | rate |
| Pure viral cultures: | | | | |
| Adenovirus type 7 Gomen | 52 | 52 | 0 | 0.0 |
| Bovine viral diarrhea | 25 | 25 | 0 | 0.0 |
| virus (BVDV) | | | | |
| Mixture of viral cultures: | | | | |
| Human herpesvirus 6B | 14 | 14 | 0 | 0.0 |
| Vaccinia virus Lister strain | 37 | 37 | 0 | 0.0 |
| Total | 51 | 51 | 0 | 0.0% |
| Overall | 128 | 128 | 0 | 0.0% |

### Example 5

### Validation of Array v2 with Known Spiked Viruses

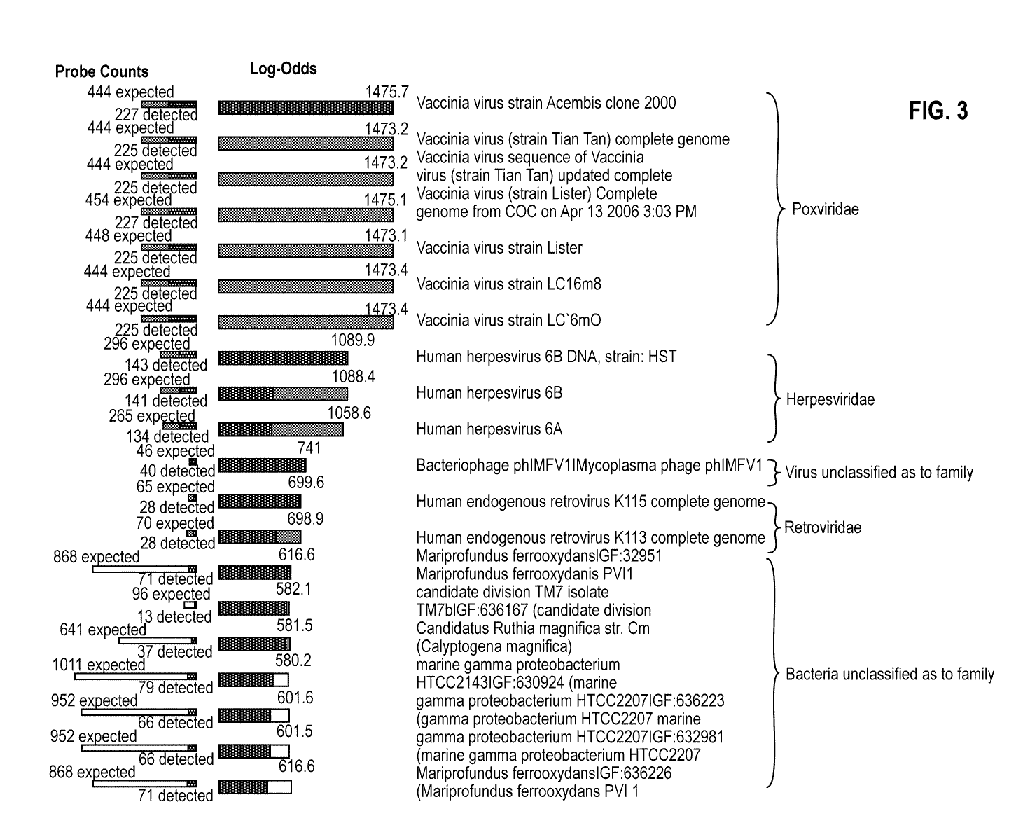

To validate v2 of the array with known spiked viruses, BVD type 1 (FIG. 2) and a mixture of vaccinia Lister and HHV 6B (FIG. 3) were tested on array v2. These organisms were correctly identified to the species level. Virus sequences selected as likely to be present are highlighted in red in these figures. On the vaccinia+HHV 6B array, human endogenous retrovirus K113 was also detected.

In addition, several organisms that were unlikely to be present were predicted, probably because of non-specific probe binding or cross-hybridization. These organisms, Mariprofundus ferrooxydans (a deep sea bacterium collected near Hawaii), candidate division TM7 (collected from a subgingival plaque in the human mouth), and marine gamma-proteobacterium (collected in the coastal Pacific Ocean at 10 m depth) were detected with low log-odds scores on numerous experiments using different samples. Genome sequences for these were not included in the probe design because they became available only after Applicants designed the microarray probes or because they were not classified into a bacterial taxonomic family; therefore probes were not screened for cross-hybridization against these targets. Genome comparisons indicate that M. ferrooxydans, TM7b, and marine gamma proteobacterium HTCC2143 share 70%, 55%, and 61%, respectively, of their sequence with other bacteria and viruses, based on simply considering every oligo of size at least 18 nt is also present in other sequenced viruses or bacteria, so many of the probes designed for other organisms may also hybridize to these targets.

### Example 6

### Testing on Blinded Samples from Pure Culture

To further test array v2, blinded samples from pure culture were tested. Blinded samples were provided from University of Texas, Medical Branch (UTMB) for 11 viruses. Applicants hybridized each of those samples separately to the MDA and predicted the identities of each virus (Table 8). 10 of 11 blinded samples were confirmed to be correctly identified by the MDA v2. VSV NJ was not detected in the 11th sample using the MDA, but was confirmed to be present by TaqMan PCR.

TABLE 8
Testing of array v2 on blinded samples from pure culture

| ID | Culture results | Array results |
|---|---|---|
| — | Vero Cells not infected | Background signal |
| TVP-11180 | Punta Toro | Punta Toro virus strain |
| | | Adames |
| TVP-11181 | Thogoto | Thogoto virus strain IIA |
| TVP-11182 | Dengue 4 | Dengue 4 strain |
| | | ThD4_0734_00 |
| TVP-11183 | CTF | Colorado tick fever virus |
| TVP-11184 | Cache Valley | Cache Valley genomic RNA |
| | | for N and NSs proteins |
| TVP-11185 | IIheus | IIheus virus |
| TVP-11186 | EHD-NJ | Epizootic hemorrhagic |
| | | disease virus isolate |
| | | 1999_MS-B NS3 |
| TVP-11187 | La Cross | La Crosse virus strain LACV |
| TVP-11188 | SF Sicilian | Sandfly fever sicilian virus |
| TVP-11189 | VSV-NJ | Not detected |
| TVP-11191 | Ross River | Ross River virus |

Ten of 11 of the species predicted by the MDA were confirmed. In addition, endogenous retroviruses were also detected by array v2 in 7 of the samples as well as the uninfected Vero cell control, indicating the presence of host DNA from the culture cells. These included one or more of the following: Baboon endogenous virus strain M7 and Human endogenous retroviruses K113, K115, and HCML-ARV, with Human endogenous retrovirus K113 being the most common.

The one sample that was not detected on the array was vesicular stomatitis virus, NJ (VSV NJ). VSV NJ was confirmed to be present in the sample using two proprietary, unpublished TaqMan assays developed by colleagues at LLNL and tested by LLNL colleagues at Plum Island that specifically detect VSV NJ. VSV NJ is a member of the Rhabdoviridae family, for which no genomes were available. Consequently, no probes were designed for this species and it was not represented in any database for the statistical analyses. It is sufficiently different from the genomes available for VSV Indiana that none of those probes had BLAST similarity to the partial sequences available for VSV NJ. There were 7 probes from the Virochip corresponding to VSV NJ that were detected. These probes were designed from partial sequences (see reference 23).

### Example 7

### Detection of Viruses and Bacteria from Clinical Samples with Array v1

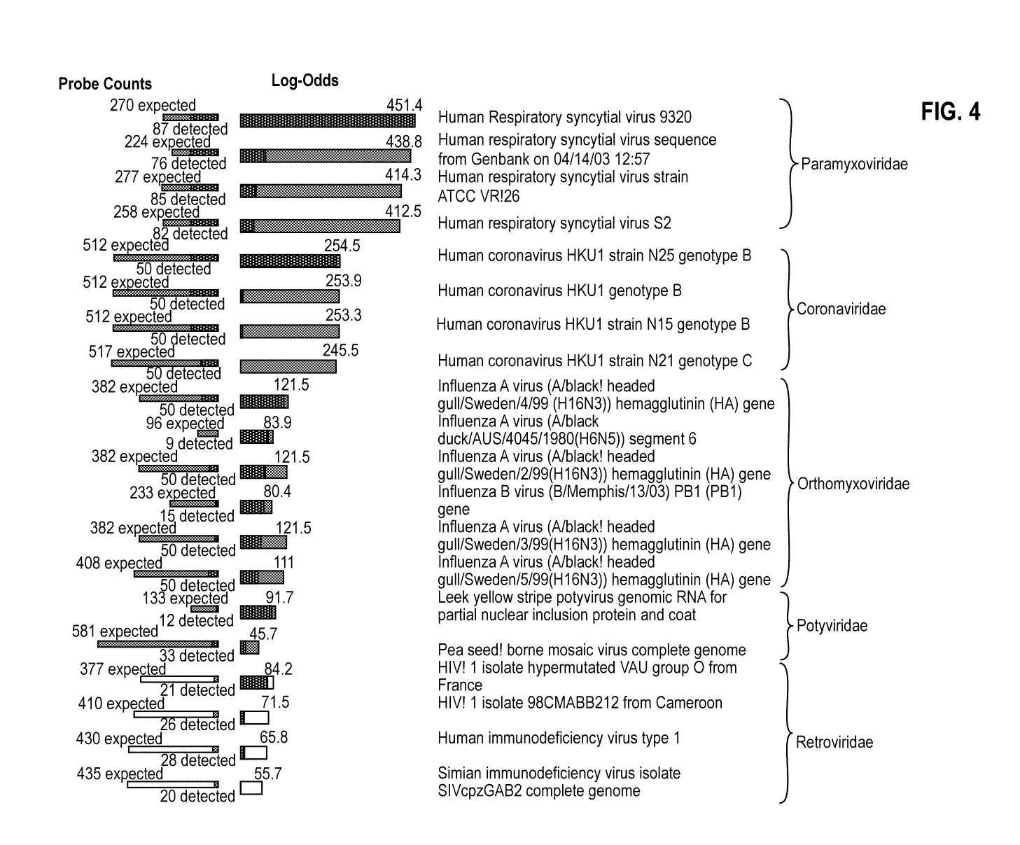

A clinical sputum sample provided from the UCSF DeRisi lab was tested on the MDA v1 (FIG. 4). Human respiratory syncytial virus and human coronavirus HKU1 were detected in this analysis. The length of a bar (FIG. 4) represents the log-likelihood contribution from probes with BLAST hits to the indicated sequence. The darker colored part of the bar represents the increase in log-likelihood that would result from adding the indicated target to the predicted set, not including contributions from previously predicted targets. Results were confirmed using specific PCR for these two viruses (Table 9). The results were also confirmed by the DeRisi lab using the ViroChip. The MDA results indicated small log-odds scores for influenza A, leek yellow stripe potyvirus, and HIV-1, although these low scores are a result of just a few probes and are likely due to nonspecific binding rather than true positives. Other samples tested using the MDA v1 also had a low likelihood predicted for Influenza A and Leek yellow stripe potyvirus (Table 6), and this is suspected to be due to non-specific binding, as discussed further in Example 8.

TABLE 9
Results from clinical samples-primer sequences,
expected product sizes, and results

| | | | | | Expected | |
|---|---|---|---|---|---|---|
| | SEQ | | SEQ | | Product | |
| | ID | Forward | ID | Reverse | Size | EPS |
| Sample | NO. | Primer | NO. | Primer | (EPS) | Detected |
| DeRset1_1 | | | | | | |
| Coronavirus | 1 | CTATGAA | 2 | GAACGGAACA | 287 | Yes |
| HKU1 | | GTCAGAT | | AGCCCATAAC | | |
| | | GAGGGTG | | ATA | | |
| | | GG | | | | |
| RSV | 3 | GGCAAAT | 4 | GACTCGTAGT | 224 | Yes |
| | | ATGGAAA | | GAAGGTCCTT | | |
| | | CATACGTG | | TGG | | |
| | | AA | | | | |
| DeRsetDR210 | | | | | | |
| Human | 5 | AGATACC | 6 | GGGTTTGTTA | 180 | Yes |
| parechovirus 1 | | ACGCTTGT | | AACCTTGGCTT | | |
| isolate BNI-788St | | GGACCTTA | | TT | | |
| Streptococcus | 7 | CGTATCTG | 8 | CGCCCCAAAC | 265 | Yes |
| thermophilus | | CCCGTATG | | AAAGAATAGC | | |
| LMD9 | | CTTG | | | | |
| DeRsetDR220 | | | | | | |
| Escherichia coli | 9 | ATCCGTCA | 10 | AGAGAAAACG | 144 | Yes |
| CFT073 | | TACGGAA | | GAAGAGTATC | | |
| | | CATCAACT | | GCC | | |
| Norwalk virus 1 | 11 | GCTCCCAG | 12 | CACCATCATT | 60 | Yes |
| | | TTTTGTGA | | AGATGGAGCG | | |
| | | ATGAAGA | | G | | |
| Norwalk virus 2 | 13 | TTCACAAA | 14 | ATGGACTTTTA | 105 | Yes |
| | | ACTGGGA | | CGTGCC | | |
| | | GCC | | | | |
| DeRsetDR230 | | | | | | |
| Chicken anemia | 15 | GTTCAGGC | 16 | TTAGCTCGCTT | 258 | Yes |
| virus | | CACCAAC | | ACCCTGTACTC | | |
| | | AAGTTC | | G | | |
| Serratia | 17 | CCGCAGA | 18 | GCCGAATCAA | 203 | No |
| proteamaculans 1 | | TCCTGGCT | | CGAAGCCTAC | | |
| | | AAAA | | | | |
| Serratia | 19 | CCCTGGGT | 20 | CCCATAGCAC | 221 | No |
| proteamaculans 2 | | AAGGTGA | | CGCTTATCCT | | |
| | | AAACG | | | | |
| DeRsetDR240 | | | | | | |
| Staphylococcus | 21 | CATGCGTA | 22 | ATGCAAACGA | 281 | Yes |
| aureus | | TTGCTATT | | GTCCAAGCAG | | |
| | | GAGTTGC | | | | |
| Shigella & E. coli | 23 | CGTCTGCT | 24 | TCTCTTCTTCC | 239 | Yes |
| conserved region | | GGATGGC | | GGCACCATT | | |
| | | TTCTA | | | | |
| Shigella sonnei | 25 | GGGTGGA | 26 | GGCTCTGGAG | 287 | Yes |
| Ss046 plasmid | | AAAGTTG | | CAGGAAAAGA | | |
| pSS046_spB | | GGATCA | | | | |
| Lactococcus | 27 | AGGTGAC | 8 | TTCGCTTGTGT | 276 | Yes |
| lactis pGdh442 | | CGTACTTT | | TCGTCCTTG | | |
| plasmid | | ACACAAT | | | | |
| | | GG | 2 | | | |
| Streptococcus | 29 | AACGAGC | 30 | TATGTACGGC | 300 | Yes |
| sanguinis | | TGTTGAGG | | GTCAAGGAGC | | |
| | | GCAAT | | | | |
| Lactococcus | 31 | TGGAAAA | 32 | TCGAGGGAAC | 232 | Yes |
| lactis pCI305 | | TTGCGTCC | | TGGGAATTTG | | |
| plasmid | | TTATTTG | | | | |
| E. coli pAPEC | 33 | CGGACGG | 34 | ATGCCTGCTC | 255 | No |
| 02-ColV plasmid | | CTACTGAA | | AACTCCATCA | | |
| 1 | | CCAAT | | | | |
| E. coli pAPEC | 35 | GCAGAAA | 36 | CTGAAGGCCA | 82 | No |
| 02-ColV plasmid | | TGAAGCT | | TCACCCGT | | |
| 2 | | GATGCG | | | | |

### Example 8

### Detection of Viruses and Bacteria from Clinical Samples with Array v2

Closer examination of probes giving high signal intensities that were not consistent with the “detected” organisms indicated the likelihood of some probes that bind non-specifically. On the MDA v2 array, 141 probes were detected in a majority (31 out of 60) of arrays hybridized to a wide variety of sample types. A small number of these probes were found to have significant BLAST hits to the human genome. Since most of the samples tested on the array were either human clinical samples or were grown in Vero cells (an African green monkey cell line), the frequent high signals for these few probes can be explained by the presence of primate DNA in the sample. The vast majority of spuriously binding probes, however, were not explained by cross-hybridization to host DNA. There were significant differences between non-specific and specific probes in the distributions of trimer entropy and hybridization free energy; non-specific probes had smaller entropies (mean 4.6 vs 4.8 bits, p=7.5×10⁻¹⁴) and more negative free energies (mean −70.5 vs −66.8 kcal/mol, p=3.8×10⁻¹³) compared to 1755 non-specific probes detected in 11 or fewer samples. Consequently, in v2 of the chip design, an entropy filter was imposed as described in the detailed description, and more probe sequences were designed at the expense of the number of replicates per probe.

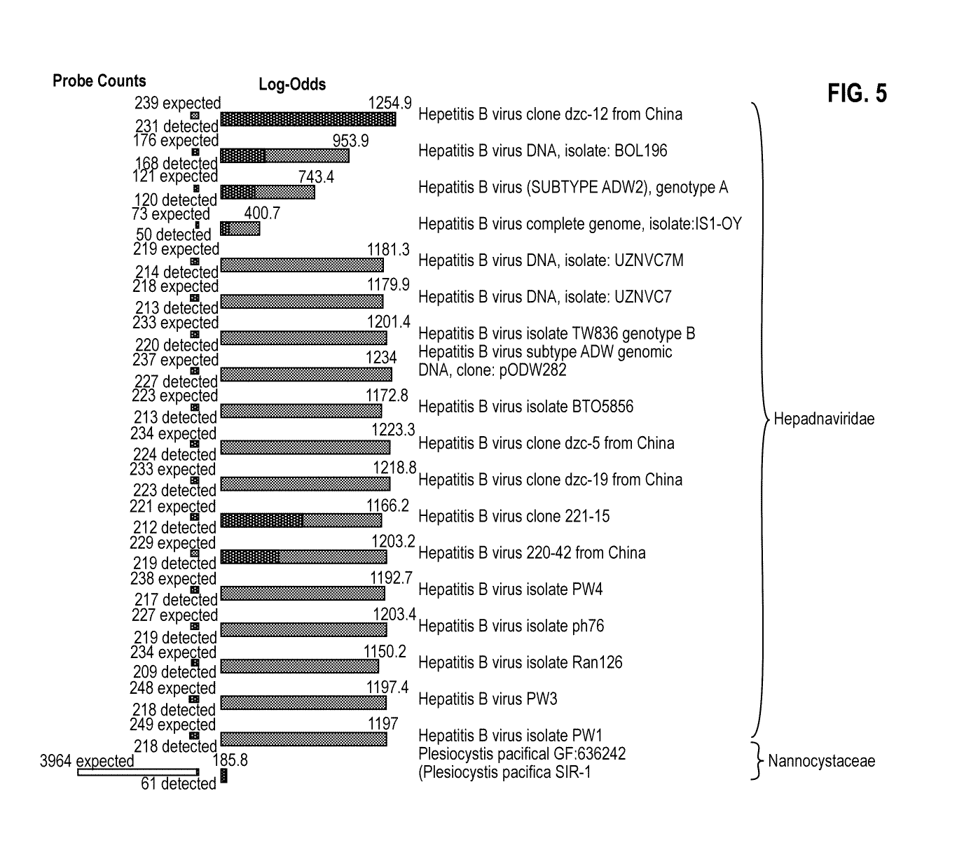

Partially amplified clinical samples provided by the DeRisi laboratory at UCSF were tested on the MDA v2. The source (e.g. fecal or serum) was blinded during experimentation and analysis, but was provided later. No patient history was provided. The results are shown in FIGS. 5-9.

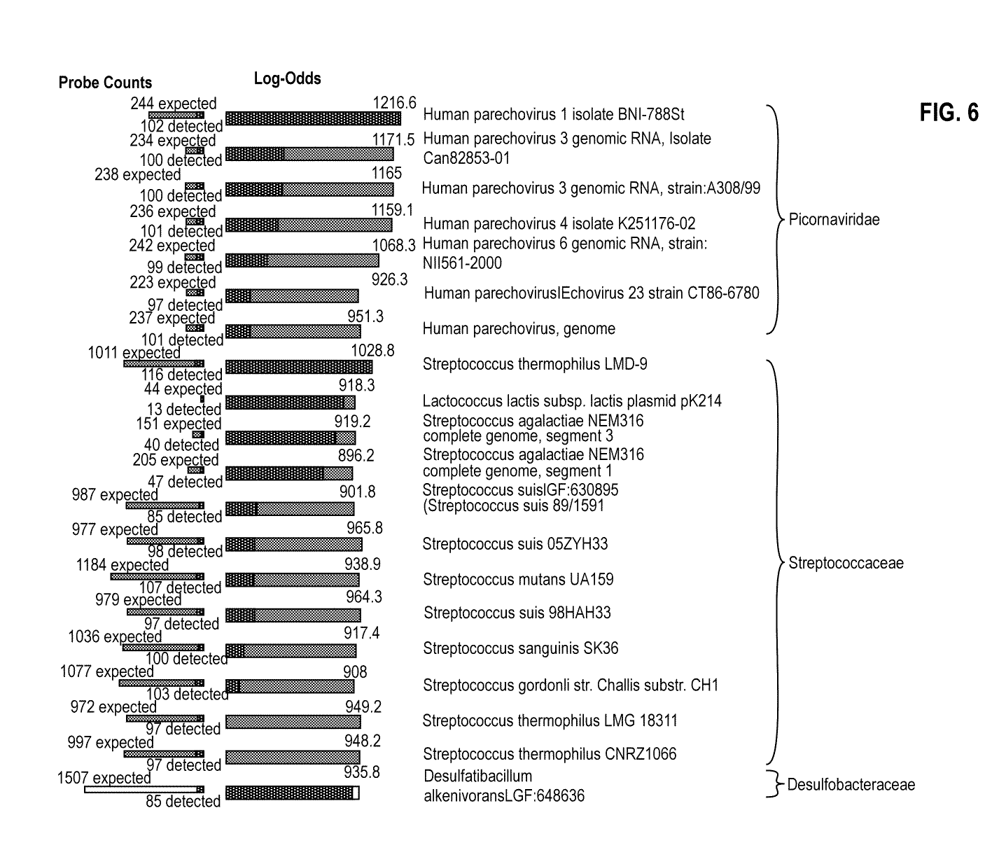

Hepatitis B virus was the only organism detected in sample 1_{—}5 (FIG. 5), and it produced a very strong signal. This was the only sample from a serum source. All the remaining samples (DR210, DR220, DR230, DR240) were from fecal sources. MDA v2 indicated that sample DR210 contained human parechovirus and a bacterium similar to Streptococcus thermophilus with a plasmid similar to one that has been sequenced from Lactococcus lactis (FIG. 6).

Other species of Streptococcaceae also had high log-odds ratios, consequently MDA v2 did not make a definitive call to the level of species. Streptococcus thermophilus is a gram-positive facultative anaerobe used as a fermenter for production of yogurt and mozzarella. It is also used as a probiotic to alleviate symptoms of lactose intolerance and gastrointestinal disturbances (see reference 12). Human parechoviruses cause mild gastrointestinal and respiratory illnesses. The presence of human parechovirus and Streptococcus thermophilus were confirmed by PCR (Table 9).

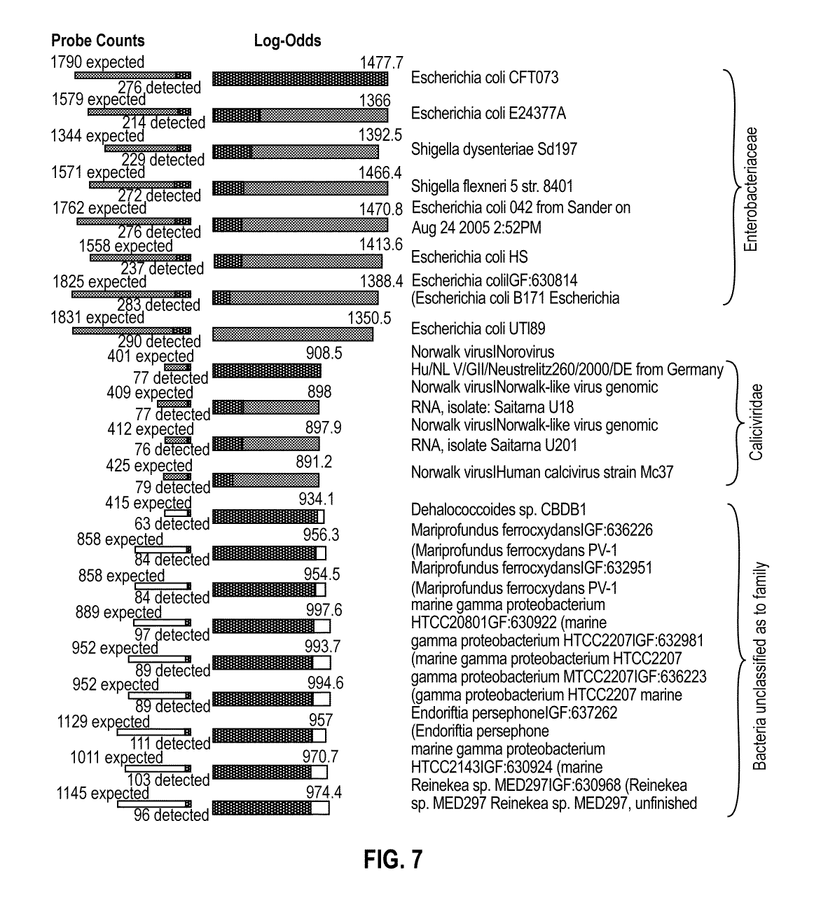

In sample DR220, Eschirichia coli CFT073 (or similar) and a Norwalk virus (FIG. 7) were identified. E. coli strain CFT073 is uropathogenic and is one of the most common causes of non-hospital acquired urinary tract infections, and Norwalk virus causes gastroenteritis. Since the probes were selected from conserved regions within a family, the array was not designed for stringent species or strain discrimination. A number of E. coli and Shigella genomes had nearly as high log-odds scores as E. coli CFT073. PCR confirmation was obtained for both E. coli and Norwalk virus (Table 9).

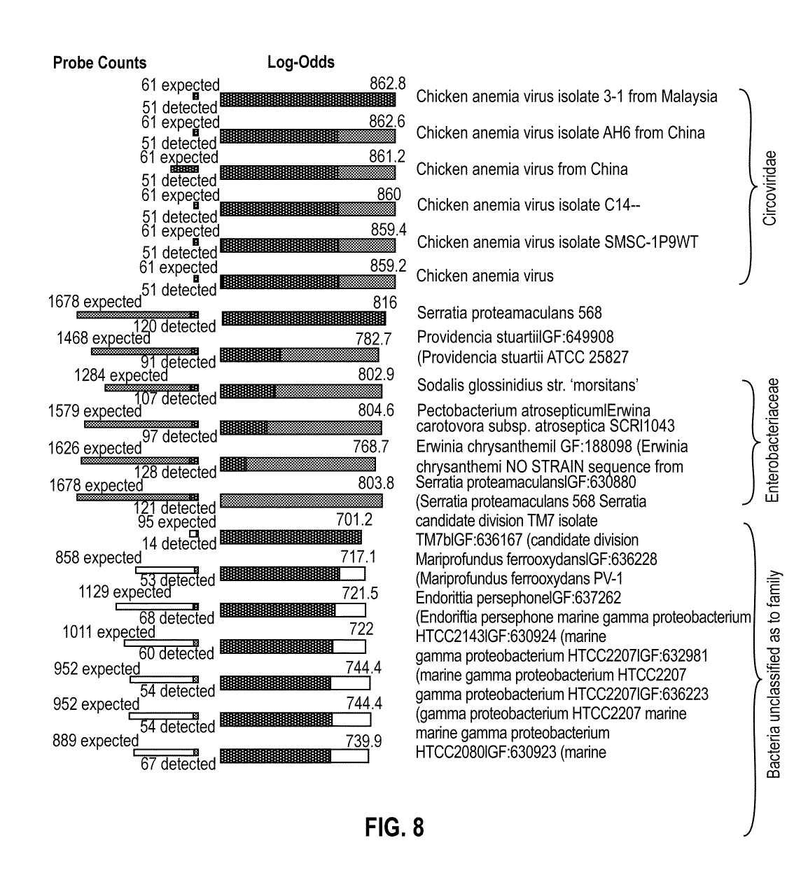

Sample DR230 was predicted to contain chicken anemia virus and Serratia proteamaculans or a related Enterobacteriaceae. S. proteamaculans has been associated with a severe form of pneumonia (see reference 2) (FIG. 8). The presence of chicken anemia was confirmed by PCR, but the presence of S. proteamaculans could not be confirmed.

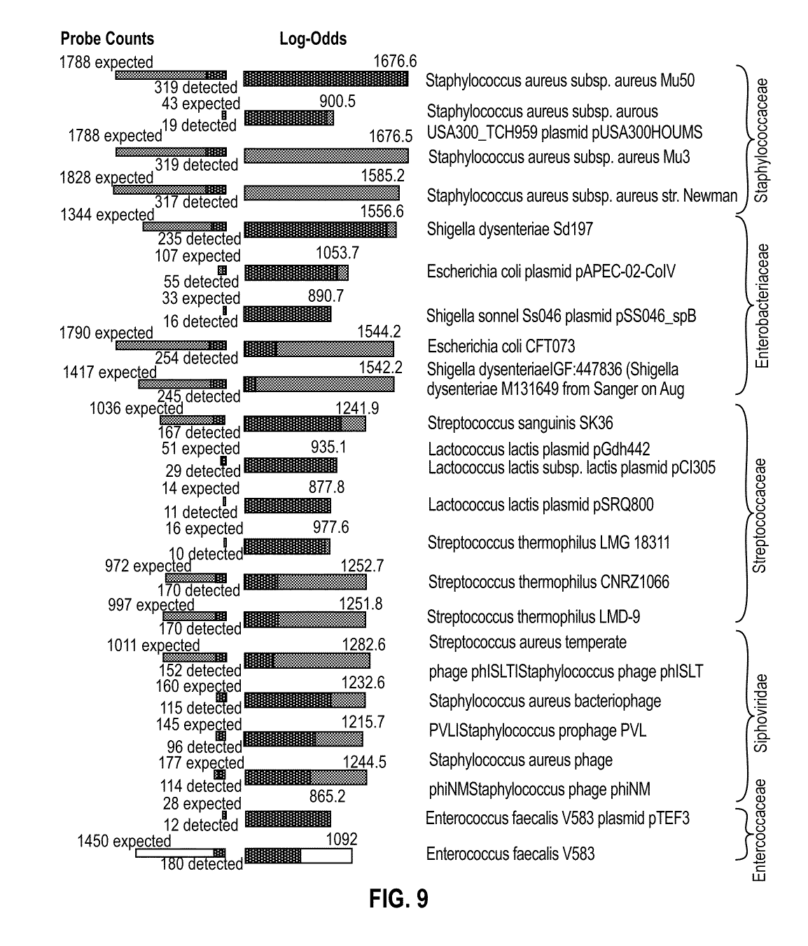

In sample DR240 only bacterial organisms were identified (FIG. 9). In particular, Staphylococcus aureus and an associated plasmid, Shigella dysentariae/E. coli and Shigella and E. coli plasmids, and Streptococcus sanguinis and related Lactococcus lactis plasmids were detected. All of these were confirmed by PCR except the E. coli pAPEC plasmid (Table 9).

### Example 9

### Limits of Detection and Hybridization Time for 4-Plex Array v2.1

Experiments were performed with the MDA v2.1 4-plex array to determine the minimum detectable quantity of viral DNA using the standard 17 hour hybridization time. In addition, experiments were conducted to determine whether shorter hybridization times could be used if there were a sufficient quantity or concentration of sample.

To test this, DNA was extracted from adenovirus type 7, Gomen strain. Sample DNA quantities ranging from 0.5 ng to 2000 ng were tested with 17 hour hybridizations, and amounts from 15.6 ng to 2000 ng were tested with 1 hour hybridizations. Arrays were analyzed with our standard maximum likelihood protocol. At 17 hours, the correct adenovirus strain was the top-scoring target for all but the smallest sample quantity tested; that is, DNA amounts as low as 1 ng (5×10⁷ genome copies) could be detected without sample amplification. With 1 hour hybridizations, the correct virus strain was identified at every DNA quantity tested, as low as 15.6 ng.

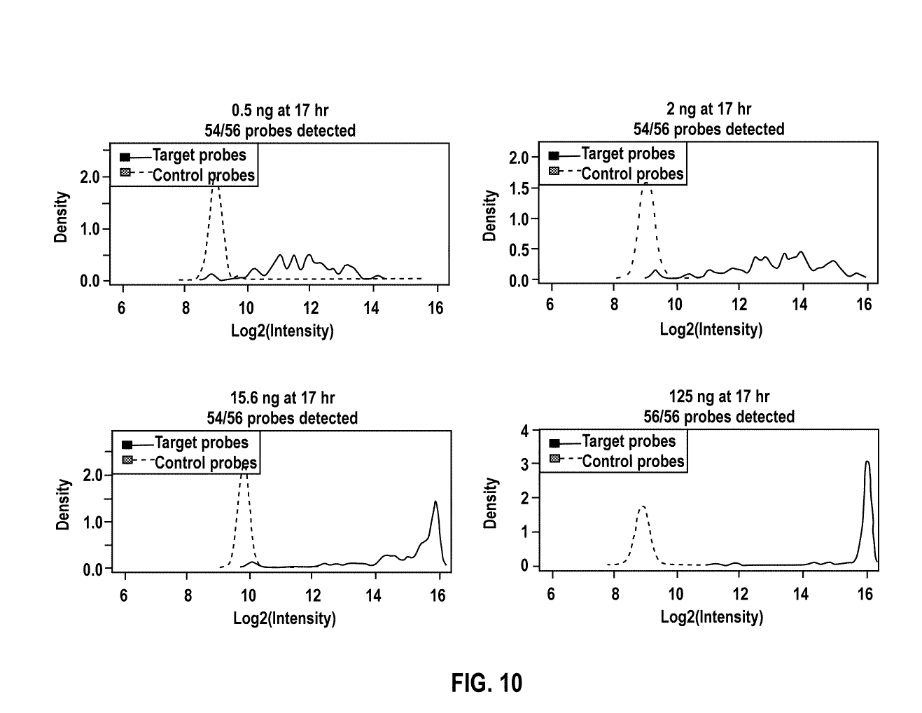

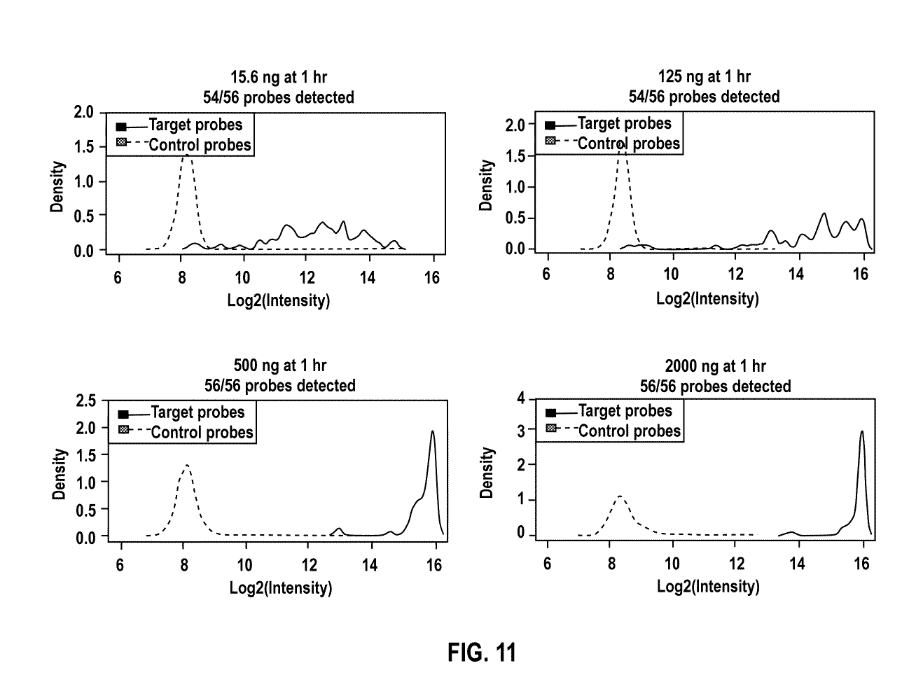

FIG. 10 shows the distribution of target-specific and negative control probe intensities observed in 4 of the 13 arrays hybridized for 17 hours at selected DNA concentrations; FIG. 11 displays corresponding distributions for 4 of the 8 one hour hybridizations at selected DNA concentrations. Separate density curves are shown for the negative control probes and the probes predicted to hybridize to the target virus genome, with detection probabilities greater than 95%. The target probes are clearly distinguished from the control probes in all cases. The target probe intensity distribution with 2 ng of DNA at 17 hours is similar to that observed with 15.6 ng at 1 hour. These results show that very short hybridization times can be used successfully when a sufficient amount of sample DNA is available.

The examples set forth above are provided to give those of ordinary skill in the art a complete disclosure and description of how to make and use the embodiments of the pan microbial detection arrays, methods and systems of the disclosure, and are not intended to limit the scope of what the inventors regard as their disclosure. Modifications of the above-described modes for carrying out the disclosure that are obvious to persons of skill in the art are intended to be within the scope of the following claims.

It is to be understood that the disclosures are not limited to particular technical applications or fields of study, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains. All references (including, but not limited to, articles, publications, patent applications and patents), mentioned in the present application are incorporated herein by reference in their entirety.

Although any methods and materials similar or equivalent to those described herein can be used in the practice for testing of the specific examples of appropriate materials and methods are described herein.

A number of embodiments of the disclosure have been described. Nevertheless, it will be understood that various modifications may be made without departing from the spirit and scope of the present disclosure. Accordingly, other embodiments are within the scope of the following claims.

### LIST OF REFERENCES

[1] Anthony, R. M., Brown, T. J. and French, G. L. (2000) Rapid Diagnosis of Bacteremia by Universal Amplification of 23S Ribosomal DNA Followed by Hybridization to an Oligonucleotide Array, J. Clin. Microbiol., 38, 781-788.
[2] Bollet, C., Grimont, P., Gainnier, M., Geissler, A., Sainty, J. M. and De Micco, P. (1993) Fatal pneumonia due to Serratia proteamaculans subsp. quinovora, J. Clin. Microbiol., 31, 444-445.
[3] Chiu, Charles Y., Rouskin, S., Koshy, A., Urisman, A., Fischer, K., Yagi, S., Schnurr, D., Eckburg, Paul B., Tompkins, Lucy S., Blackburn, Brian G., Merker, Jason D., Patterson, Bruce K., Ganem, D. and DeRisi, Joseph L. (2006) Microarray Detection of Human Parainfluenzavirus 4 Infection Associated with Respiratory Failure in an Immunocompetent Adult, Clinical Infectious Diseases, 43, e71-e76.
[4] Chou, C.-C., Lee, T.-T., Chen, C.-H., Hsiao, H.-Y., Lin, Y.-L., Ho, M.-S., Yang, P.-C. and Peck, K. (2006) Design of microarray probes for virus identification and detection of emerging viruses at the genus level, BMC Bioinformatics, 7, 232.
[5] DeSantis, T., Brodie, E., Moberg, J., Zubieta, I., Piceno, Y. and Andersen, G. (2007) High-Density Universal 16S rRNA Microarray Analysis Reveals Broader Diversity than Typical Clone Library When Sampling the Environment, Microbial Ecology, 53, 371-383.
[6] Giegerich, R., Kurtz, S, and Stoye, J. (2003) Efficient implementation of lazy suffix trees, Software-Practice and Experience, 33, 1035-1049.
[7] Jabado, O. J., Liu, Y., Conlan, S., Quan, P. L., Hegyi, H., Lussier, Y., Briese, T., Palacios, G. and Lipkin, W. I. (2008) Comprehensive viral oligonucleotide probe design using conserved protein regions, Nucl. Acids Res., 36, e3.
[8] Jaing, C., Gardner, S., McLoughlin, K., Mulakken, N., Alegria-Hartman, M., Banda, P., Williams, P., Gu, P., Wagner, M., Manohar, C. and Slezak, T. (2008) A Functional Gene Array for Detection of Bacterial Virulence Elements, PLoS ONE, 3, e2163.
[9] Jin, L.-Q., Li, J.-W., Wang, S.-Q., Chao, F.-H., Wang, X.-W. and Yuan, Z.-Q. (2005) Detection and identificatio of intestinal pathogenic bacteria by hybridization to oligonucleotide microarrays, World J Gastroenterol, 11, 7615-7619.
[10] Kessler, N., Ferraris, O., Palmer, K., Marsh, W. and Steel, A. (2004) Use of the DNA Flow-Thru Chip, a Three-Dimensional Biochip, for Typing and Subtyping of Influenza Viruses, J. Clin. Microbiol., 42, 2173-2185.
[11] Lin, B., Blaney, K. M., Malanoski, A. P., Ligler, A. G., Schnur, J. M., Metzgar, D., Russell, K. L. and Stenger, D. A. (2007) Using a Resequencing Microarray as a Multiple Respiratory Pathogen Detection Assay, J. Clin. Microbiol., 45, 443-452.
[12] Makarova, K., Slesarev, A., Wolf, Y., Sorokin, A., Mirkin, B., Koonin, E., Pavlov, A., Pavlova, N., Karamychev, V., Polouchine, N., Shakhova, V., Grigoriev, I., Lou, Y., Rohksar, D., Lucas, S., Huang, K., Goodstein, D. M., Hawkins, T., Plengvidhya, V., Welker, D., Hughes, J., Goh, Y., Benson, A., Baldwin, K., Lee, J. H., Dosti, B., Smeianov, V., Wechter, W., Barabote, R., Lorca, G., Alternann, E., Barrangou, R., Ganesan, B., Xie, Y., Rawsthorne, H., Tamir, D., Parker, C., Breidt, F., Broadbent, J., Hutkins, R., O'Sullivan, D., Steele, J., Unlu, G., Saier, M., Klaenhammer, T., Richardson, P., Kozyavkin, S., Weimer, B. and Mills, D. (2006) Comparative genomics of the lactic acid bacteria, Proceedings of the National Academy of Sciences, 103, 15611-15616.
[13] Nakamura, S., Yang, C.-S., Sakon, N., Ueda, M., Tougan, T., Yamashita, A., Goto, N., Takahashi, K., Yasunaga, T., Ikuta, K., Mizutani, T., Okamoto, Y., Tagami, M., Morita, R., Maeda, N., Kawai, J., Hayashizaki, Y., Nagai, Y., Horii, T., Lida, T. and Nakaya, T. (2009) Direct Metagenomic Detection of Viral Pathogens in Nasal and Fecal Specimens Using an Unbiased High-Throughput Sequencing Approach, PLoS ONE, 4, e4219.
[14] Palacios, G., Quan, P.-L., Jabado, O., Conlan, S., Hirschberg, D. and Liu Y, e.a. (2007) Panmicrobial oligonucleotide array for diagnosis of infectious diseases, Emerg Infect Dis 13, http://www.cdc.gov/ncidod/EID/13/11/73.htm.
[15] Quan, P.-L., Palacios, G., Jabado, O. J., Conlan, S., Hirschberg, D. L., Pozo, F., Jack, P. J. M., Cisterna, D., Renwick, N., Hui, J., Drysdale, A., Amos-Ritchie, R., Baumeister, E., Savy, V., Lager, K. M., Richt, J. A., Boyle, D. B., Garcia-Sastre, A., Casas, I., Perez-Brena, P., Briese, T. and Lipkin, W. I. (2007) Detection of Respiratory Viruses and Subtype Identification of Influenza A Viruses by GreeneChipResp Oligonucleotide Microarray, J. Clin. Microbiol., 45, 2359-2364.
[16] Rota, P. A., Oberste, M. S., Monroe, S. S., Nix, W. A., Campagnoli, R., Icenogle, J. P., Penaranda, S., Bankamp, B., Maher, K., Chen, M.-h., Tong, S., Tamin, A., Lowe, L., Frace, M., DeRisi, J. L., Chen, Q., Wang, D., Erdman, D. D., Peret, T. C. T., Burns, C., Ksiazek, T. G., Rollin, P. E., Sanchez, A., Liffick, S., Holloway, B., Limor, J., McCaustland, K., Olsen-Rasmussen, M., Fouchier, R., Gunther, S., Osterhaus, A. D. M. E., Drosten, C., Pallansch, M. A., Anderson, L. J. and Bellini, W. J. (2003) Characterization of a Novel Coronavirus Associated with Severe Acute Respiratory Syndrome, Science, 300, 1394-1399.
[17] Satya, R., Zavaljevski, N., Kumar, K. and Reifman, J. (2008) A high-throughput pipeline for designing microarray-based pathogen diagnostic assays, BMC Bioinformatics, 9, doi: 10.1186/1471-2105-1189-1185.
[18] Sengupta, S., Onodera, K., Lai, A. and Melcher, U. (2003) Molecular Detection and Identification of Influenza Viruses by Oligonucleotide Microarray Hybridization, J. Clin. Microbiol., 41, 4542-4550.
[19] Singh-Gasson, S., Green, R., Yue, Y., Nelson, C., Blattner, F., Sussman, M. and Cerrina, F. (1999) Maskless fabrication of light-directed oligonucleotide microarrays using a digital micromirror array, Nat Biotechnol 17, 974-978.
[20] Slezak, T., Kuczmarski, T., Ott, L., Tones, C., Medeiros, D., Smith, J., Truitt, B., Mulakken, N., Lam, M., Vitalis, E., Zemla, A., Zhou, C. E. and Gardner, S. (2003) Comparative genomics tools applied to bioterrorism defense, Briefings in Bioinformatics, 4, 133-149.
[21] Urisman, A., Molinaro, R. J., Fischer, N., Plummer, S. J., Casey, G., Klein, E. A., Malathi, K., Magi-Galluzzi, C., Tubbs, R. R., Ganem, D., Silverman, R. H. and DeRisi, J. L. (2006) Identification of a Novel Gammaretrovirus in Prostate Tumors of Patients Homozygous for R462Q<italic>RNASEL</italic>Variant, PLoS Pathog, 2, e25.
[22] Wang, D., Coscoy, L., Zylberberg, M., Avila, P. C., Boushey, H. A., Ganem, D. and DeRisi, J. L. (2002) Microarray-based detection and genotyping of viral pathogens, Proceedings of the National Academy of Sciences of the United States of America, 99, 15687-15692.
[23] Wang, D., Urisman, A., Liu, Y., Springer, M., Ksiazek, T., Erdman, D., Mardis, E., Hickenbotham, M., Magrini, V., Eldred, J., Latreille, J., Wilson, R., Ganem, D. and DeRisi, J. (2003) Viral Discovery and Sequence Recovery Using DNA Microarrays, PLoS Biol., 1, e2.
[24] Wang, X.-W., Zhang, L., Jin, L.-Q., Jin, M., Shen, Z.-Q., An, S., Chao, F.-H. and Li, J.-W. (2007) Development and application of an oligonucleotide microarray for the detection of food-borne bacterial pathogens, Applied Microbiology and Biotechnology, 76, 225-233.
[25] Wong, C., Heng, C., Wan Yee, L., Soh, S., Kartasasmita, C., Simoes, E., Hibberd, M., Sung, W.-K. and Miller, L. (2007) Optimization and clinical validation of a pathogen detection microarray, Genome Biology, 8, R93.
[26] Li, W. and Godzik, A. (2006) Cd-hit: a fast program for clustering and comparing large sets of protein or nucleotide sequences. Bioinformatics, 22, 1658-1659.
[27] SantaLucia, J. and Hicks, D. (2004) The thermodynamics of DNA strucutural motifs. Ann. Rev. Biophys. Biomol. Struct., (33):415-440.

What is claimed is:

1. A method to obtain a plurality of oligonucleotide probes for detection of targets of a target group, comprising:
identifying group-specific candidate probes from an initial genomic collection by eliminating from the initial collection regions with matches to non-group targets above a match threshold and by selecting regions satisfying probe characteristics, said probe characteristics including at least one criterion selected from length, Tₘ, GC %, maximum homopolymer length, homodimer free energy prediction, hairpin free energy prediction, probe-target free energy prediction, and minimum trimer frequency entropy condition;
ranking the group-specific candidate probes in decreasing order of number of targets of the target group represented by each group-specific candidate probe; and
selecting probes from the ranked group-specific candidate probes.

2. The method of claim 1, wherein selecting probes from the ranked group-specific candidate probes comprises, for each target, selecting the most conserved or least conserved probes representing that target until each target genome is represented by a predetermined number of probes.

3. The method of claim 1, further comprising clustering together candidate probes sharing at least 85% identity and selecting the longest sequence from each cluster as a target for probe design.

4. The method of claim 1, wherein the at least one criterion is relaxed to obtain at least a minimum number of candidate probes for each target.

5. The method of claim 1, wherein a target is represented if a candidate probe matches with at least 85% sequence similarity over the total candidate probe length and a perfectly matching subsequence of at least 29 contiguous bases spans the middle of the probe.

6. The method of claim 1, wherein the group is selected between a viral family, a bacterial family, a viral sequence group classified under a taxonomic node other than family, and a bacterial sequence group classified under a taxonomic node other than family.

7. The method of claim 6, wherein the group is a viral family and the probes are at least 50 per target.

8. The method of claim 6, wherein the group is a bacterial family and the probes are at least 15 per target.

9. The method of claim 1, wherein the probes are at least 50 bases long.

10. The method of claim 6, wherein group-specific regions are identified for probe selection that do not have a match of an oligonucleotide of x or more nucleotides long with sequences not part of the group, x being an integer.

11. The method of claim 10, where the group is a viral family or a bacterial family and where x=17 nucleotides for a viral family and x=25 nucleotides for a bacterial family.

12. A plurality of oligonucleotide probes for detection of targets of a target group, the plurality obtained with the method of claim 1.

13. An array comprising the plurality of oligonucleotide probes according to claim 12.

14. The array of claim 13, wherein the number of probes of the array differs according to the target.

15. A method of classifying an oligonucleotide probe sequence as detected or undetected in a biological sample, comprising:
incubating fluorescently labeled target DNA synthesized from templates extracted from a biological sample on an array comprising a plurality of probes, to allow for hybridization of target DNA to any probes of the array having sequences similar to those of the target DNA, producing a variable number of target-probe hybridization products for each probe sequence;
scanning the array to measure an aggregate fluorescence intensity value for each feature comprising a set of target-probe hybridization products having probes of the same sequence;
calculating the distribution of feature intensity values for target-probe hybridization products by way of negative control probes with randomly generated sequences, and setting a minimum detection threshold for the array; and
comparing the observed feature intensity value for each probe sequence with the minimum detection threshold determined for the array, to classify each probe sequence on the array as either detected or undetected in the biological sample.

16. A method of predicting likelihood of presence of a target of known nucleotide sequence in a biological sample, comprising:
applying the method of claim 15 to classify probe sequences on an array as detected or undetected in the sample;
estimating, for each detected probe sequence:
i) a probability of observing the probe sequence as detected conditioned on presence of the target of known nucleotide sequence;
ii) a probability of observing the probe sequence as detected conditioned on absence of the target of known nucleotide sequence; and
iii) the detection log-odds, defined as the ratio of i) and ii);
estimating, for each undetected probe sequence:
iv) a probability of observing the probe sequence as undetected conditioned on presence of the target of known nucleotide sequence;
v) a probability of observing the probe sequence as undetected conditioned on absence of the target of known nucleotide sequence; and
vi) the nondetection log-odds, defined as the ratio of iv) and v);
summing detection and nondetection log-odds values over the probes on the array to form an aggregate log-odds score for presence versus absence of the target of known nucleotide sequence, conditional on the observed detected and undetected probes; and
based on the aggregate log-odds score, providing a prediction of the presence of at least one said target of known nucleotide sequence in the biological sample.

17. A selection method for selecting, from a list of candidate target sequences of known nucleotide sequence, a target sequence most likely to be present in a biological sample, the selection method comprising:
applying the method of claim 16 to each of the candidate target sequences, and choosing the target sequence that yields the maximum aggregate log-odds score.

18. The method of claim 16, wherein i) is estimated by performing a BLAST alignment of the probe sequence and target of known nucleotide sequence, and evaluating a logistic probability density function with BLAST bit score, predicted melting temperature, and position of an aligned portion of the target of known nucleotide sequence within the probe sequence as covariates, and coefficients fitted to data from arrays hybridized to targets of known nucleotide sequence.

19. The method of claim 16, wherein i) is estimated by performing a BLAST alignment of the probe sequence and target of known nucleotide sequence, and evaluating a logistic probability density function with predicted free energy of the probe-target hybridization as covariate, and coefficients fitted to data from arrays hybridized to targets of known nucleotide sequence.

20. The method of claim 16, wherein ii) is estimated as a logistic function of probe sequence entropy, computed from a frequency distribution of nucleotide trimers within the probe sequence.

21. A selection method for selecting, from a list of candidates, a set of targets whose presence in a biological sample would collectively provide the best explanation for observed detected and undetected probes on an array, comprising:
a) applying the method of claim 17 to identify the target most likely to be present in the sample;
b) removing the identified target from the list of candidates and adding the identified target to the “selected” list;
c) repeating the method of claim 17 for the remaining candidates, wherein:
c1) estimation of i), ii) and iii) is replaced with estimation of:
i′) a probability of observing the probe sequence as detected conditioned on presence of the candidate target and presence of targets in the list of selected targets;
ii′) a probability of observing the probe sequence as detected conditioned on absence of the candidate target and presence of targets in the list of selected targets; and
iii′) the detection log-odds, defined as the ratio of i′) and ii′);
c2) estimation of iv), v) and vi) is replaced with estimation of:
iv′) a probability of observing the probe sequence as undetected conditioned on presence of the candidate target and presence of targets in the list of selected targets;
v′) a probability of observing the probe sequence as undetected conditioned on absence of the candidate target and presence of the targets in the list of selected targets; and
vi′) the nondetection log-odds, defined as the ratio of iv′) and v′);
c3) the detection and nondetection log-odds values are summed over the probes on the array to form a conditional log-odds score for presence versus absence of the candidate target, conditioned on the observed detected and undetected probes and on the presence of the targets in the list of selected targets;
d) choosing the candidate target yielding the maximum conditional log-odds score, removing it from the candidate list, and adding it to the list of selected targets; and
e) repeating c) and d) until the conditional log-odds scores for all remaining candidate targets are less than zero.


SEQUENCE LISTING (36 sequences)

SEQ ID NO: 1 - DNA, 23 bp, Artificial
  Synthetic Oligonucleotide
ctatgaagtcagatgagggtggg

SEQ ID NO: 2 - DNA, 23 bp, Artificial
  Synthetic Oligonucleotide
gaacggaacaagcccataacata

SEQ ID NO: 3 - DNA, 24 bp, Artificial
  Synthetic Oligonucleotide
ggcaaatatggaaacatacgtgaa

SEQ ID NO: 4 - DNA, 23 bp, Artificial
  Synthetic Oligonucleotide
gactcgtagtgaaggtcctttgg

SEQ ID NO: 5 - DNA, 23 bp, Artificial
  Synthetic Oligonucleotide
agataccacgcttgtggacctta

SEQ ID NO: 6 - DNA, 23 bp, Artificial
  Synthetic Oligonucleotide
gggtttgttaaaccttggctttt

SEQ ID NO: 7 - DNA, 20 bp, Artificial
  Synthetic Oligonucleotide
cgtatctgcccgtatgcttg

SEQ ID NO: 8 - DNA, 20 bp, Artificial
  Synthetic Oligonucleotide
cgccccaaacaaagaatagc

SEQ ID NO: 9 - DNA, 23 bp, Artificial
  Synthetic Oligonucleotide
atccgtcatacggaacatcaact

SEQ ID NO: 10 - DNA, 23 bp, Artificial
  Synthetic Oligonucleotide
agagaaaacggaagagtatcgcc

SEQ ID NO: 11 - DNA, 23 bp, Artificial
  Synthetic Oligonucleotide
gctcccagttttgtgaatgaaga

SEQ ID NO: 12 - DNA, 21 bp, Artificial
  Synthetic Oligonucleotide
caccatcattagatggagcgg

SEQ ID NO: 13 - DNA, 18 bp, Artificial
  Synthetic Oligonucleotide
ttcacaaaactgggagcc

SEQ ID NO: 14 - DNA, 17 bp, Artificial
  Synthetic Oligonucleotide
atggacttttacgtgcc

SEQ ID NO: 15 - DNA, 21 bp, Artificial
  Synthetic Oligonucleotide
gttcaggccaccaacaagttc

SEQ ID NO: 16 - DNA, 23 bp, Artificial
  Synthetic Oligonucleotide
ttagctcgcttaccctgtactcg

SEQ ID NO: 17 - DNA, 19 bp, Artificial
  Synthetic Oligonucleotide
ccgcagatcctggctaaaa

SEQ ID NO: 18 - DNA, 20 bp, Artificial
  Synthetic Oligonucleotide
gccgaatcaacgaagcctac

SEQ ID NO: 19 - DNA, 20 bp, Artificial
  Synthetic Oligonucleotide
ccctgggtaaggtgaaaacg

SEQ ID NO: 20 - DNA, 20 bp, Artificial
  Synthetic Oligonucleotide
cccatagcaccgcttatcct

SEQ ID NO: 21 - DNA, 23 bp, Artificial
  Synthetic Oligonucleotide
catgcgtattgctattgagttgc

SEQ ID NO: 22 - DNA, 20 bp, Artificial
  Synthetic Oligonucleotide
atgcaaacgagtccaagcag

SEQ ID NO: 23 - DNA, 20 bp, Artificial
  Synthetic Oligonucleotide
cgtctgctggatggcttcta

SEQ ID NO: 24 - DNA, 20 bp, Artificial
  Synthetic Oligonucleotide
tctcttcttccggcaccatt

SEQ ID NO: 25 - DNA, 20 bp, Artificial
  Synthetic Oligonucleotide
gggtggaaaagttgggatca

SEQ ID NO: 26 - DNA, 20 bp, Artificial
  Synthetic Oligonucleotide
ggctctggagcaggaaaaga

SEQ ID NO: 27 - DNA, 24 bp, Artificial
  Synthetic Oligonucleotide
aggtgaccgtactttacacaatgg

SEQ ID NO: 28 - DNA, 20 bp, Artificial
  Synthetic Oligonucleotide
ttcgcttgtgttcgtccttg

SEQ ID NO: 29 - DNA, 20 bp, Artificial
  Synthetic Oligonucleotide
aacgagctgttgagggcaat

SEQ ID NO: 30 - DNA, 20 bp, Artificial
  Synthetic Oligonucleotide
tatgtacggcgtcaaggagc

SEQ ID NO: 31 - DNA, 22 bp, Artificial
  Synthetic Oligonucleotide
tggaaaattgcgtccttatttg

SEQ ID NO: 32 - DNA, 20 bp, Artificial
  Synthetic Oligonucleotide
tcgagggaactgggaatttg

SEQ ID NO: 33 - DNA, 20 bp, Artificial
  Synthetic Oligonucleotide
cggacggctactgaaccaat

SEQ ID NO: 34 - DNA, 20 bp, Artificial
  Synthetic Oligonucleotide
atgcctgctcaactccatca

SEQ ID NO: 35 - DNA, 20 bp, Artificial
  Synthetic Oligonucleotide
gcagaaatgaagctgatgcg

SEQ ID NO: 36 - DNA, 18 bp, Artificial
  Synthetic Oligonucleotide
ctgaaggccatcacccgt